(19) United States
(12) Patent Application Publication
(10) Pub. No.: US 2016/0364774 A1
(43) Pub. Date: Dec. 15, 2016

(54) SINGLE ACTION MULTI-DIMENSIONAL FEEDBACK GRAPHIC SYSTEM AND METHOD

(71) Applicants: Richard WITTSIEPE, Duisburg (DE); Andreas STEEGER, Oberengstringen (CH)

(72) Inventors: Richard WITTSIEPE, Duisburg (DE); Andreas STEEGER, Oberengstringen (CH)

(21) Appl. No.: 15/178,970

(22) Filed: Jun. 10, 2016

Related U.S. Application Data
(60) Provisional application No. 62/173,697, filed on Jun. 10, 2015.

(51) Int. Cl. G06Q 30/02; G06F 3/0481; G06F 3/0482

(52) U.S. Cl. CPC G06Q 30/0282; G06F 3/0482; G06F 3/04815

(57) ABSTRACT

A computer-implemented method and system for providing a feedback rating with a single user input over the internet or email. Data may be received indicative of enablement of a single action feedback process, such as after resolution of an interaction between a customer and client. Responsive to receipt of the enablement data, the single action multi-dimensional feedback graphic is generated and then transmitted to a customer via a network browser or email. A desired feedback rating is identified by selecting (e.g. clicking with a pointer of a pointing device, touching a desired area on a touchscreen, or by voice input) a discrete area of the multi-dimensional feedback graphic, which may represent a combination of a plurality of feedback ratings and parameters. After the feedback selection is made, the selected feedback information may be transmitted to the server and stored.

### CROSS-REFERENCE TO RELATED APPLICATIONS

This application claims the benefit of U.S. Provisional Application 62/173,697 filed on Jun. 10, 2015, the entire contents of which are herein incorporated by reference for all purposes.

### FIELD OF INVENTION

The present disclosure relates to a system and computer-executable method for rating or otherwise providing feedback for a transaction or service, or ratings for products, via a single user action or selection.

### BACKGROUND

After many remote electronic transactions, such as the online purchase of a product and/or a service, a client or customer is invited to participate in a survey. This survey may consist of questions for the client to answer, and/or a form of rating or feedback the client is asked to provide. By way of example only, a client may be asked to rate his or her experience using a numeric or symbolic scale. Such feedback may also include providing separate ratings for various aspects of a given transaction (e.g. a rating for communication and a separate rating for the speed at which the transaction was completed). At least from the client's perspective, one drawback of this feedback process is the time-consuming nature of filling in survey responses, including providing multiple feedback ratings. As a result, client participation rates or feedback rates tend to be low compared to, for example, a total number of transactions.

Similarly, in supply chain management or inventory management, quality assurance data corresponding to the quality of goods is desirable to ensure that products received are of sufficient quality, which then ensures that products provided to others are of sufficient quality. However, cumbersome software and systems to rate product quality, which require a user to provide several separate input responses for each product, results in one or both of a time-consuming process which expends high levels of employee time or missed data inputs by employees, which reduces the effectiveness of the overall data.

As will be understood by one of ordinary skill in the art, an internet networking system connects computers and server systems via various services such as electronic mail and the world wide web, for enabling the transmission and display of text and/or graphics-based emails, and web pages, by way of example only. Current electronic mail (email) systems are typically defined using Hypertext Markup Language (HTML), which provides a standard set of tags that define how an email or webpage is to be displayed. Thus, when an email is received by a client, the client's email program uses HTML to display the email. Likewise, when a webpage is accessed by a client, a client's browser renders the HTML page for display. These HTML documents (e.g. a webpage or email) may contain uniform resource locator identifiers (URLs) of other web pages on the server system, or other server systems, to which a client may directly navigate. The client may also be automatically directed to other destinations, without the need for additional input.

The world wide web is widely used to conduct electronic commerce. Similarly, in the business world, companies typically utilize an internal network or intranet. By accessing an intranet, a client or customer can request services, raise incidents, order products and/or engage in other commercial activities. As set forth above, at the conclusion of one or more of these transactions, a survey or feedback invitation may be sent to the client to obtain feedback regarding the quality of the experience. If an intranet is used, security is generally not at issue, as the intranet is typically isolated or otherwise not accessible via the world wide web. However, when browsing the world wide web, security threats are more prevalent. While a feedback invitation may not contain sensitive information such as credit card numbers, birthdates, and the like, both vendors and clients should be alert to ensure the security of this information. To further enhance security, the underlying parameters sent to a given server can be scrambled and/or encryption techniques, such as HTTPS (an encrypted version of Hypertext Transfer Protocol or HTTP) implemented within the protocol.

Improved systems and methods for providing a secure, efficient means to provide or enhance feedback on transactions or ratings of products are desired.

### SUMMARY

In one embodiment of the present disclosure, a method for capturing transaction feedback from a customer or client is provided. The method includes receiving, from a client computer system, data indicative of enablement of a single action feedback process for capturing transaction feedback data from a customer computing device. Responsive to receiving the data indicative of enablement, the method generates, by a feedback platform computer system, a multi-dimensional feedback graphic including a plurality of discrete selectable areas, each of the plurality of discrete selectable areas corresponding to distinct feedback values of at least two feedback parameters. The multi-dimensional feedback graphic is transmitted to a customer computing device for selection of one of the plurality of discrete selectable areas by the customer. The customer's selection is received by the feedback platform computer system from the customer computing device, the selection comprising feedback data corresponding to the at least two feedback parameters corresponding to the selected one of the plurality of discrete selectable areas on the multi-dimensional feedback graphic. The method further includes storing the feedback data in in a data storage device.

In an embodiment of the present disclosure, the method further includes monitoring, by a client computer system, a plurality of customer service interactions with customers. Then, based on the monitoring by the client computer system, a resolution event for one or more of the plurality of customer service interactions is identified. Responsive to identification of the resolution event for one of the plurality of customer service interactions, the method enables the single action feedback process, generates the multi-dimensional feedback graphic, transmits the multi-dimensional feedback graphic to the customer computing device, and receives the selection of one of the plurality of discrete selectable areas by a customer.

In another embodiment of the present disclosure, a system for capturing rating feedback from a client is provided. The system includes a network interface unit configured to receive data indicative of a request to enable a single action rating process for capturing transaction rating data from a quality assurance computing device. The system also includes a processor configured, responsive to receipt of the request to enable the single action rating process, to generate a multi-dimensional rating graphic including a plurality of discrete selectable areas, each of the plurality of discrete selectable areas corresponding to distinct rating values of at least two rating parameters. The processor may also be configured to transmit, by the network interface unit to the quality assurance computing device, the multi-dimensional rating graphic for selection of one of the plurality of discrete selectable areas by a client. The network interface unit receives from the quality assurance computing device, a selection of one of the plurality of discrete selectable areas on the multi-dimensional rating graphic, the selection comprising rating data corresponding to the at least two rating parameters corresponding to the selected one of the plurality of discrete selectable areas on the multi-dimensional rating graphic. The process is also configured to store, in a data storage device, the rating data.

In another embodiment of the present disclosure, a ratings scanner device is provided. The ratings scanner device comprises an RFID transceiver, a display, and a processor. The display is configured to display a multi-dimensional rating graphic and receive a selection corresponding to the multi-dimensional rating graphic. The processor is configured to receive, by the RFID transceiver, the RFID data from a RFID tag and generate, responsive to receipt of the RFID data from the RFID tag, a multi-dimensional rating graphic including a plurality of discrete selectable areas, each of the plurality of discrete selectable areas corresponding to distinct rating values of at least two rating parameters. The processor is further configured to render the multi-dimensional rating graphic on the display, and also to receive a selection of one of the plurality of discrete selectable areas on the multi-dimensional rating graphic, the selection comprising rating data corresponding to the at least two rating parameters corresponding to the selected one of the plurality of discrete selectable areas on the multi-dimensional rating graphic. The scanner device stores the rating data in a data storage device, and also stores, by the RFID transceiver in the RFID tag, the rating data corresponding to the at least two rating parameters. The ratings scanner device continuously repeats the generate, render, receive, and store steps for each product scanned by the device.

### BRIEF DESCRIPTION OF THE DRAWINGS

FIG. 1 illustrates a process flow diagram of an exemplary single-action feedback method according to an embodiment of the present disclosure.

FIG. 2 illustrates a first exemplary feedback graphic used in the single-action feedback method of FIG. 1.

FIG. 3 illustrates a second exemplary feedback graphic which may be used in the single-action feedback method of FIG. 1.

FIG. 4 illustrates a process flow diagram of an aspect of the single-action feedback method according to an embodiment of the present disclosure.

FIG. 5 illustrates a first exemplary system for implementing the single-action feedback method according to an embodiment of the present disclosure.

FIG. 6 illustrates a second exemplary system for implementing the single-action feedback method according to an embodiment of the present disclosure.

FIG. 7 illustrates an exemplary platform for implementing the single-action feedback method according to an embodiment of the present disclosure.

FIG. 8 illustrates a process flow diagram of an exemplary implementation of the single-action feedback method into an existing online feedback service platform.

FIG. 9 illustrates a process flow diagram of another exemplary single-action rating feedback method according to an embodiment of the present disclosure.

FIG. 10 illustrates a process flow diagram of another exemplary single-action rating feedback method according to an embodiment of the present disclosure.

FIG. 11 illustrates a high level configuration and a specific configuration of exemplary systems for storing ratings feedback.

FIGS. 12A-12F illustrate additional exemplary rating feedback graphics used in the single-action feedback methods of FIG. 1 and FIG. 9.

FIG. 13 illustrates an exemplary interface for viewing feedback data obtained according to the single-action feedback method according to an embodiment of the present disclosure.

FIG. 14 illustrates an exemplary interface for creating a single-action feedback graphic according to the single-action feedback method according to an embodiment of the present disclosure.

FIG. 15 illustrates a rendering of the single-action feedback graphic on a first exemplary device.

FIG. 16 illustrates a rendering of the single-action feedback graphic on a second exemplary device.

FIG. 17 illustrates a rating scanner device according to an embodiment of the present disclosure.

FIG. 18 illustrates a process flow diagram of a second exemplary implementation of the single-action feedback method into an existing online feedback service platform.

FIG. 19 illustrates a process flow diagram of a process optimization method which implements the single-action feedback method.

FIG. 20 illustrates an exemplary interface for viewing the points structure for the process optimization method of FIG. 19.

### DETAILED DESCRIPTION

It is to be understood that the figures and descriptions of the present disclosure have been simplified to illustrate elements that are relevant for a clear understanding of the embodiments described herein, while eliminating, for purposes of clarity, many other elements found in computing systems and associated networks, including local and internet networks, as well as computer systems or mobile telephones running native or web-based applications or other software. However, because such elements are well known in the art, and because they do not facilitate a better understanding of the present invention, a discussion of such elements is not provided herein. The disclosure herein is directed to all such variations and modifications known to those skilled in the art.

An embodiment of the present disclosure provides a computer-implemented method and system for placing or providing feedback or a rating (which are used interchangeably or together herein) with a single-action input. This input may be in the form of a single action or actuation of a computer input device such as a pointing device (e.g., a mouse or touchpad) or other input hardware of a personal computing device, or a single touch of a sensing surface of a touch-screen enabled computing device. In one embodiment, a feedback graphic is generated and displayed to a client via an email or provided on a web page. In one embodiment, the feedback graphic can be rendered (e.g. by making use of HTML tags such as the table tag), or it may comprise part of an application. The feedback graphic may be segmented into a plurality of discrete, selectable areas. Each discrete area may represent a value or rating associated with two or more feedback parameters in embodiments. After the feedback selection is made, a remote server may automatically be contacted, and the selected feedback information, associated customer (the entity giving feedback) or client (the entity for whom feedback is being given) information, company information, incident or purchase identification information, and a security token may be transmitted to the server. Upon receipt of this information, the server may assign the feedback rating to the corresponding incident identification or purchase identification for storage on a feedback database.

Embodiments of the present disclosure facilitate the collection of customer feedback information about service delivery quality and may be configured for industrial and financial companies in after-service research and survey procedures. Embodiments may be used in existing products which gather feedback about service delivery. Embodiments reduce the level of customer interaction necessary for placing accurate feedback, thereby alleviating the drawbacks of prior art systems.

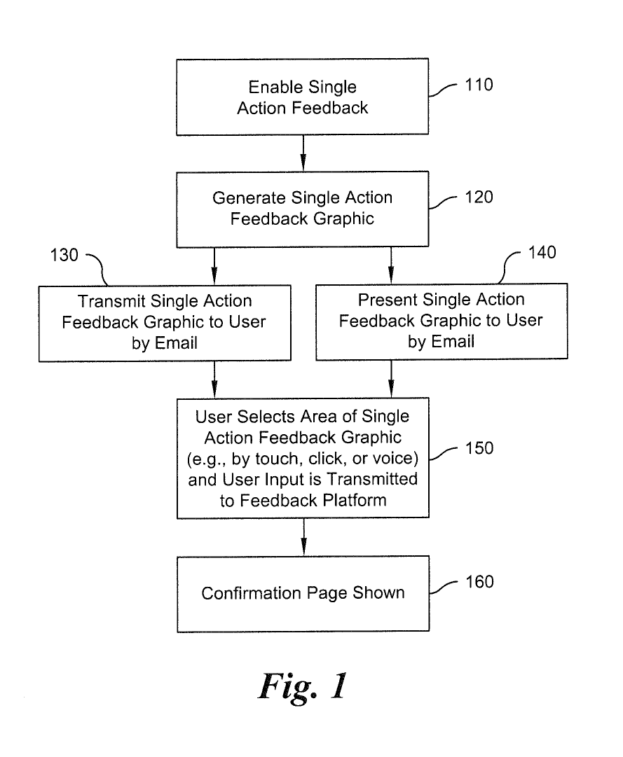

FIGS. 1-3 illustrate a single-action feedback or rating system and method according to an embodiment of the present disclosure. Referring generally to FIG. 1, in an exemplary method 100 according to the present disclosure, a single action or single action multi-dimensional feedback graphic (or graphical image or graphic interface) having discrete regions or areas thereof associated with various feedback or rating criteria is generated and feedback received. At block 110, the single action feedback process is enabled. In an embodiment, the single action feedback process may be enabled after the completion of a transaction or interaction between a customer and a vendor-client, such as completing a purchase transaction with an online merchant. Any transaction or interaction for which a client desires feedback may be configured to trigger or enable the feedback or rating process, such as completion of a customer service call with a vendor. In an embodiment, a vendor or client system may be configured to monitor customer service interactions with customers and identify, based on the monitoring, whether the resolution of an interaction or event has occurred. When the resolution of the interaction is identified or detected, the vendor system may enable the single action feedback process. In an embodiment, the vendor/client system may transmit a notification to the feedback platform computer system of the resolution of the interaction, thereby enabling the single action feedback process to be implemented for the interaction.

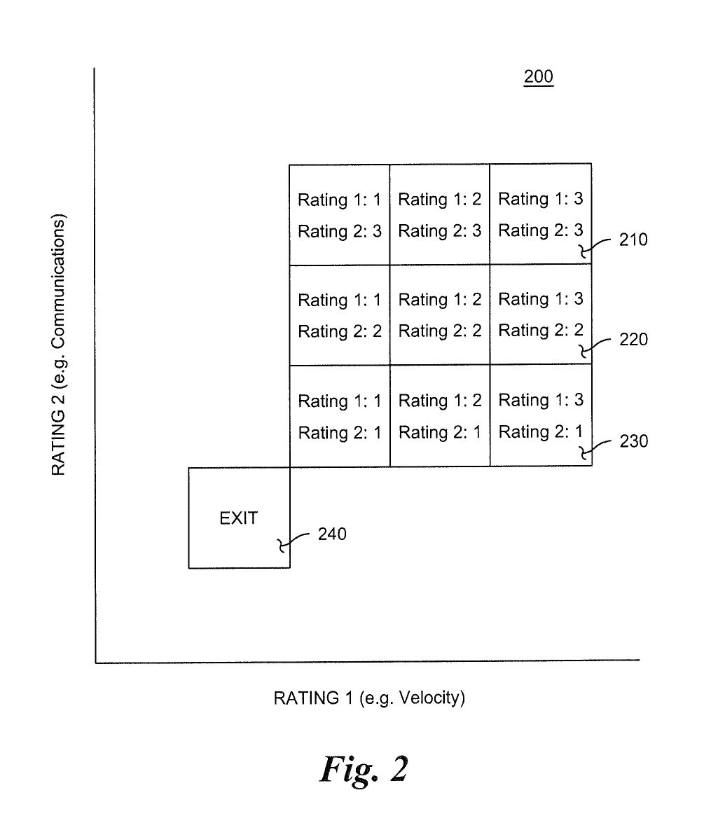

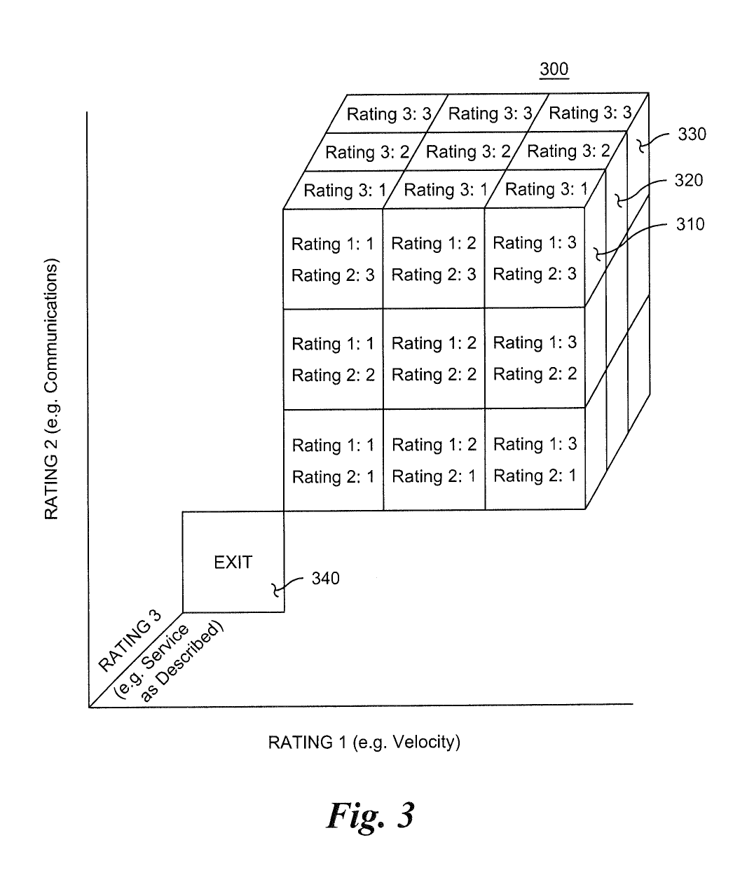

Enabling of the single action feedback process may cause a feedback platform computer system to generate a single action multi-dimensional feedback graphic at block 120 and transmit that graphic to a customer for response 130-140. As described in relation to FIGS. 2 and 3, the single action multi-dimensional may be two or three dimensional, and includes discrete selectable areas, each representing a combination of feedback parameters and associated ratings. In one embodiment, an electronic communication (e.g. an email) is generated which includes the feedback graphic and is transmitted electronically 130 to a customer. In an alternative embodiment, the feedback graphic is displayed to the customer via a web page 140, for example after the customer has completed an online transaction with the online merchant client. As will be set forth in greater detail herein, the customer may select 150 a discrete area of the feedback graphic associated with one or more desired feedback values. Selection by the customer is typically performed by the customer using a pointing device to position an indicator on the desired discrete area of the feedback graphic and then initiating selection on the point devices, such as clicking a button one or more times, or by the customer touching, on a device that has a touch screen interface, the area of the feedback graphic. Alternatively, the single action may constitute a voice input by the user of a particular discrete area. In embodiments, once selected, a confirmation page or confirmation email reflecting the feedback selection may be generated and provided to the client 160. In another embodiment, a confirmation page or email reflecting the feedback selection may be generated and provided to the customer. The feedback data corresponding to the selected area may also be saved in a data storage device of the feedback platform.

FIG. 2 illustrates a first exemplary multi-dimensional feedback graphic 200 used in the single-action feedback method of FIG. 1. The feedback graphic 200 is multi-dimensional because it obtains feedback data for more than one feedback parameter. As set forth above, this feedback graphic may be sent to a customer after the conclusion of an interaction with the customer, such as when a purchase order has been taken, an inquiry (incident) raised, or a service has been consumed. The exemplary feedback graphic shown consists of individual selectable areas, each representing a combination of feedback parameters and associated ratings. In the illustrated two-dimensional embodiment, two distinct parameters or ratings can be measured; the X-Axis is associated with a first rating (e.g. rating 1, a Communication Rating); the Y-Axis is associated with a second rating (e.g. rating 2, a Transaction Time or Velocity Rating). As shown, the selectable area associated with box 210 represents the optimal, and therefore best or highest rating or feedback value of 3 for rating 1 and rating 2. The selectable areas associated with illustrated boxes 220 and 230 have respective rating values of 2 and 1 for rating 2 and a rating value of 3 for rating 1. Should a client desire to exit the survey without the selection (and subsequent recordation) of feedback, illustrated box or field 240 may be selected. In one embodiment, the selection of box 240 may be presumed to indicate that a client was dissatisfied with the transaction (e.g. the issue/incident was not resolved). Accordingly, selection of box 240 may be operative to mark the survey accordingly (e.g. “User has complaints”). In a further embodiment, selection of box 240, in addition to optionally marking the survey, may automatically generate an action item instructing a provider to contact the client regarding their presumed dissatisfaction. In other embodiments, selection of box 240 may simply exit the survey, without marking the survey in any manner.

As shown in FIG. 2, the feedback graphic may include axes (i.e. an x-axis and y-axis) which indicate the parameters that are being rated, such as, in FIG. 2, velocity and communications. In addition to the graphics, each of the discrete box areas may include an information display of the feedback parameter values that correspond with the box. In addition, in embodiments each of the individual selectable areas may be configured to visually differentiate itself from the other selectable areas when a cursor is located within the selectable area. For example, the color of the selectable area may change, or the font may change, so that the user knows that the cursor is within the selected area, thereby making the selection process easier for the user. In embodiments, the multi-dimensional feedback graphic may be configured to change over time such that the information displayed by one or more of the plurality of discrete selectable areas changes over time. The multi-dimensional feedback graphic may also be configured to change over time such that the distinct feedback values corresponding to one or more of the plurality of discrete selectable areas changes over time and the information displayed by the one or more of the plurality of discrete selectable areas also changes over time.

As noted, selection by the customer of an area on the multi-dimensional graphic is typically performed by the customer clicking their pointing device on the desired discrete area of the feedback graphic, or by the customer touching, on a device that has a touch screen interface, the area of the feedback graphic. In embodiments, the multi-dimensional graphic may be configured so that a user can select a discrete area via a voice input to the user's computing device which is displaying the multi-dimensional graphic. For example, a multi-dimensional graphic may be generated so that it is designed to receive a voice input, and turns on or connects to a microphone to receive the voice input when the graphic is displayed. Alternatively, a multi-dimensional graphic may be generated so that it is designed to receive either a manual (e.g., mouse or touch) input or voice input, with the graphic providing an optional icon to select which input will be used, or an option icon to select voice input when the graphic is configured by default to receive a manual input. In embodiments in which the graphic is configured to receive voice input to select a discrete area of the graphic, the graphic may include, for each discrete area, identifier information which the user may use (i.e. speak) to select the area. For example, the graphic of FIG. 2 includes nine discrete block areas for selection by a user. In an embodiment, the boxes can be marked and designated with the identifiers such as “Box 1,” “Box 2,” through “Box 9,” in which box 240 corresponds to “Box 1” and box 210 corresponds to “Box 4.” To select box 210, the user may say “select Box 4” or “Box 4.” To select box 240, the user may say “select Box 1” or “Box 1,” or in embodiments “Exit.” Any type of designator or identifier may be used which enables the use to select discrete boxes, and in embodiments the boxes may be designated with alphabetical identifiers (e.g., Box A, Box B, etc.), alphanumeric identifiers (e.g. Box A1, Box A2, etc.), or colors (e.g., Red Box, Blue Box, etc.). In an embodiment, the voice selection functionality may be integrated with existing functionality or applications on a user device, such as the SIRI voice application on APPLE devices, the OK GOOGLE voice application on GOOGLE devices, and the CORTANA voice application on MICROSOFT devices.

While FIG. 2 illustrates a two-dimensional feedback graphic, it should be understood that other feedback graphics according to embodiments of the present disclosure may take on other forms. By way of non-limiting example only, FIG. 3 illustrates a three-dimensional feedback graphic in the exemplary form of a cube. The feedback graphic may include axes (i.e. an x-axis, y-axis, and z-axis) which indicate the parameters that are being rated. This embodiment provides for three discrete feedback rating parameters and associated ratings. The cube comprises a plurality of discrete feedback areas or sub-cubes associated with various combinations of feedback parameters and ratings. In an embodiment, the cube may be decomposed (e.g. separated), rotated, or otherwise manipulated by a client using an input interface device (e.g. a mouse) in order to access an area, box or sub-cube associated with a target (e.g. desired) feedback combination. As illustrated, area or sub-cube 330 is associated with a best rating value of 3 for each of the first, second, and third ratings or parameters 1,2,3. Sub-cube 320 is associated with a rating value of 3 for ratings 1 and 2, and a value of 2 for rating 3, and sub-cube 310 is associated with a rating value of 3 for ratings 1 and 2, a rating value of 1 for rating 3. It should be understood that while a rating scale, and ratings or parameters, of 1-3 are illustrated, the scale or number of parameters may be increased or decreased to other desired amounts, and the dimensions of the cube or three-dimensional graphic altered accordingly. Similar to box 240 in FIG. 2, box 340 of FIG. 3 may permit a client to exit the survey without the selection (and subsequent recordation) of feedback. In one embodiment, the selection of box 340 may be presumed to indicate that a client was dissatisfied with the transaction (e.g. the issue/incident was not resolved). Accordingly, selection of box 340 may be operative to mark the survey accordingly (e.g. “User has complaints”). In a further embodiment, selection of box 340, in addition to optionally marking the survey, may automatically generate an action item instructing a provider to contact the client regarding their presumed dissatisfaction. In other embodiments, selection of box 340 may simply exit the survey, without marking the survey in any manner.

The three-dimensional feedback graphic of FIG. 3 may also include internal boxes which correspond with different rating values. For example, the internal box in the center of the graphic shown in FIG. 3 would have a value of 2 for each of ratings 1, 2, and 3. The feedback/rating platform may be configured to provide a user access to the internal boxes for selection, as well as the boxes (e.g., boxes on the back, bottom, and left side of the cube) not otherwise viewable in a conventional two dimensional representation. As noted, in embodiments the cube may be decomposed (e.g. separated), rotated, or otherwise manipulated by a client using an input interface device (e.g. a mouse) in order to access an area, box or sub-cube associated with a target (e.g. desired) feedback combination. In an embodiment, access to the internal boxes can be provided through selection of an “exploded” view of the boxes in which each of the boxes, including the internal and back side boxes, are shown individually in a manner so that adjacent boxes do not touch each other in the exploded view, which provides access to the internal and rear boxes. In another embodiment, access to the internal boxes can be provided through the generation of a transparent cube. For example, the transparent cube may include a “node” in each block which can be selected, which permits internal blocks and other non-forward facing boxes to be chosen. In embodiments, each of the individual selectable areas may be configured to visually differentiate itself from the other selectable areas when a cursor is located within the selectable area. For example, the color of the selectable area may change, or the font may change, so that the user knows that the cursor is within the selected area, thereby making the selection process easier for the user. Other types of graphics which allow selection of internal and other non-forward facing boxes may also be generated.

The single click multidimensional feedback graphic may also be configured to operate with holographic and/or virtual reality systems, hardware, and software. A holographic system may use light to generate a three dimensional representation of the multi-dimensional feedback graphic. A pointing device, such as a mouse or a pointing device worn on the user's finger, which is calibrated such that the position of the pointing device is known relative to a projected hologram, may be used to “touch” the hologram and select one of the discrete areas of the hologram. Alternatively, the holographic system may include one or more sensors or cameras which sense gestures by the user such as the position of the user's fingers with respect to the hologram, and which incorporates gestures for the user to select holograms and perform actions with the holograms. These gestures may be considered a single action or a “touch” or “click.” In embodiments, the hologram is transparent, which permits the user to reach into the image and select internal discrete areas of the feedback hologram. The hologram system may also include microphones or other sensors which permit the user to select discrete boxes by voice input.

A hologram may include a device worn by the user, which projects the three dimensional feedback graphic and/or senses the position of the user's fingers in relation to the hologram. For example, the MICROSOFT HOLOLENS system may be used to generate holographic feedback graphics, which system also includes sensors for sensing user gestures and microphones for receiving voice commands. In other embodiments, the hologram may be generated by a user wearable device with a camera, which is configured to generate the holographic multi-dimensional feedback graphic as part of an augmented reality which augments the real world with holograms, in which the camera senses the selection of a discrete area by the user. For example, the EPSON MOVERIO platform includes a see-through wearable display with a camera which permits the generation of the holographic multi-dimensional feedback graphic as part of an augmented reality and senses gestures by the user including the selection of a discrete box by the user.

A virtual reality system may also be used to present a user with the three-dimensional representation of the feedback graphic and receive a selection of a discrete area of the graphic by the user. While a virtual reality system typically completely replaces the real world with a virtual world, unlike an augmented or mixed reality system which mixes holograms with the real world, the concepts used with holographic feedback graphics and selection of discrete areas within the feedback graphics work similarly within the virtual reality system. Thus, the virtual reality system will generate a three-dimensional hologram which the user may see and access, and will typically include sensors or pointing devices which may be used to perform gestures such as selecting a discrete area within the feedback graphic.

While two-dimensional and three-dimensional graphics are shown providing feedback for two and three discrete ratings or parameters, respectively, it should be understood that the additional dimension of time may be included for each of these graphics for providing a client or user with additional feedback criteria. For example, the feedback graphic may change with time in order to present a user with additional selection options or feedback parameters from which to select.

All varieties of the single action multi-dimensional feedback graphic, including the two-dimensional and three-dimensional graphics shown in FIGS. 2 and 3, are unconventional and previously unknown in the field of feedback graphics. When consumers engage in face-to-face transactions with merchants or sellers, the sellers are able to gauge the reaction (e.g., is the customer satisfied, upset) of the consumer during personal interaction. However, because many transactions are now performed through the internet rather than in person, it is not possible for the seller to gauge the consumer's reaction to the transaction. While prior art feedback mechanisms have been developed to obtain feedback for internet or electronic transactions, as noted, a drawback of the existing feedback processes is that they require a user to provide a number of inputs to provide feedback, such as a separate score for each different parameter being checked (e.g., Velocity and Communication). Requiring the user to provide a plurality of separate inputs is seen by customers as time-consuming, and has resulted in low client participation rates when giving feedback because the customers simply do not provide feedback when they are required to answer too many questions. For example, it has been observed that only 10% of feedback surveys are completed by customers.

In contrast, the present single action feedback graphic permits the user to provide feedback relating to a number of different parameters in a single action, which has been seen to greatly increase the participation rates seen by clients. Thus, the single action or single action feedback graphic is better able to provide sellers or merchants feedback in relation to internet or electronic sales by preventing users from simply ignoring feedback processes which require too many steps by the consumer. In an embodiment, the single action feedback graphic may be used to replace an “END” or “EXIT” button in an existing application. For example, the “End Call” button in a video conferencing application like SKYPE may be replaced with a single action feedback graphic, for example to rate the speech quality and stability of the video conference. In this embodiment, the user selects a feedback to end a call, resulting in a 100% participation feedback rate for the application.

Further, the implementation of the unconventional single action feedback graphic also provides technical benefits to the feedback platform implementing the graphic. First, because the graphic requires only a single input by the user, the number of communications between the user and the platform are reduced several magnitudes. For example, while a three-dimensional graphic feedback interface may receive feedback relating to three different parameters, this is accomplished in only two communications between the user and the feedback platform—transmittal of the graphic to the user, and receipt of the input by the feedback platform. In contrast, in prior art systems in which a user would be required to provide a separate input for each parameters, the interaction would require six communications between the user and the feedback platform. Thus, the single action feedback graphic results in 67% fewer communications transactions, which, when it is considered that feedback may be solicited thousands of times a day, results in substantial savings in both network interface unit usage and processor usage associated with transmitting and receiving feedback data.

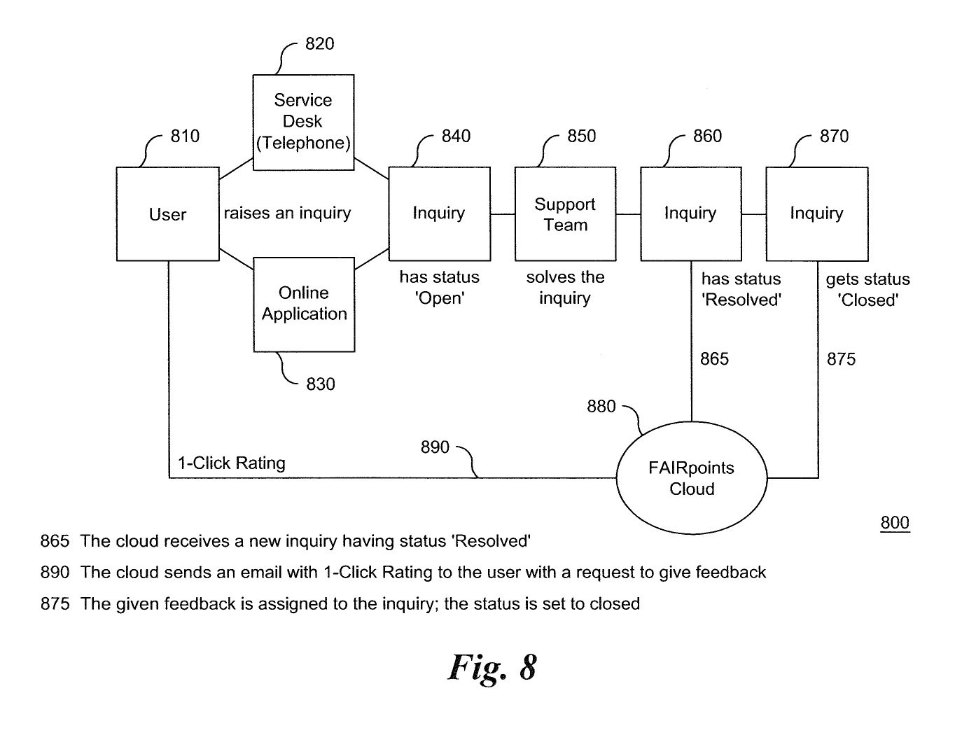

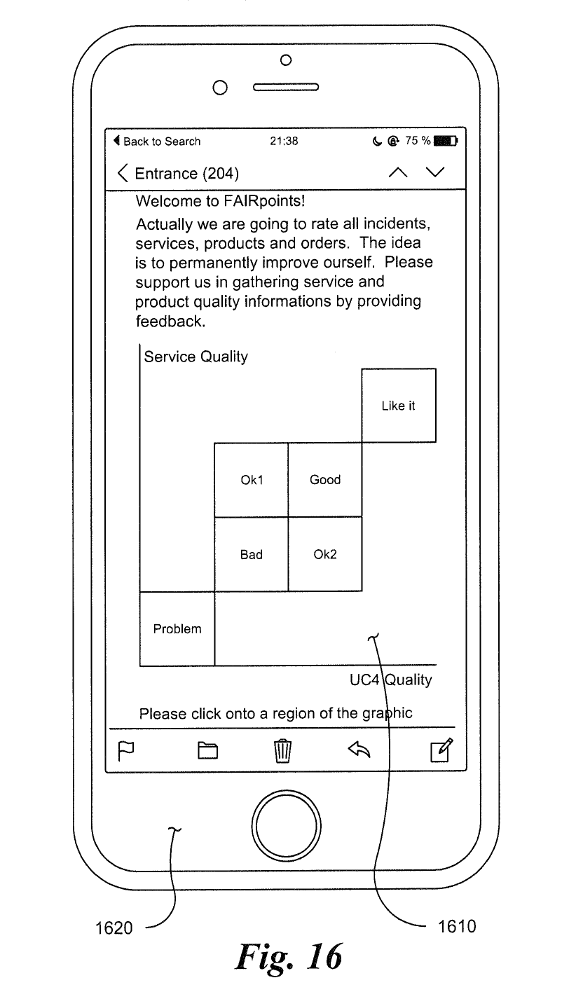

In addition, the implementation of single action feedback graphic also provides clients with greater flexibility in configuration of feedback systems because of the inherent efficiency of the single action graphic. For example, FIGS. 8 and 16 depict implementations in which the single action graphic is integrated with existing feedback systems. Because the single action graphic requires generation of only a single graphic and receipt of only a single input corresponding to that graphic, it is more easily integrated with existing systems than prior art systems which require multiple interactions between the user and feedback platform. Furthermore, because the single action feedback graphic reduces the amount of communications and processor resources used in relation to feedback as compared to prior art systems, the single action feedback graphic is also more easily integrated into existing systems without the need for additional networking and processor hardware resources to handle the additional feedback, as would be needed with prior art systems.

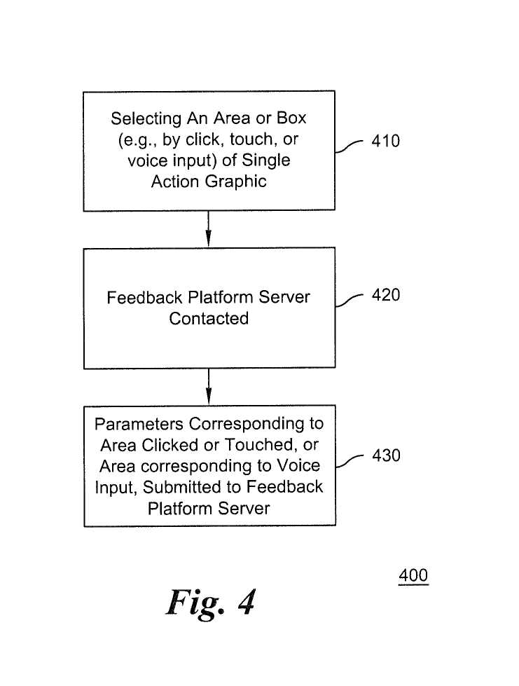

Referring generally to the method 400 of FIG. 4, upon selection 410 of the box or area of the feedback graphic by a client (e.g. by the click of a mouse or other input interface device), the system may automatically redirect 420 or contact a server system. Once a connection with the server system is established, the feedback results may be transmitted or submitted 430 thereto. Once received, a result or confirmation page may be provided to the client or customer/user for feedback verification.

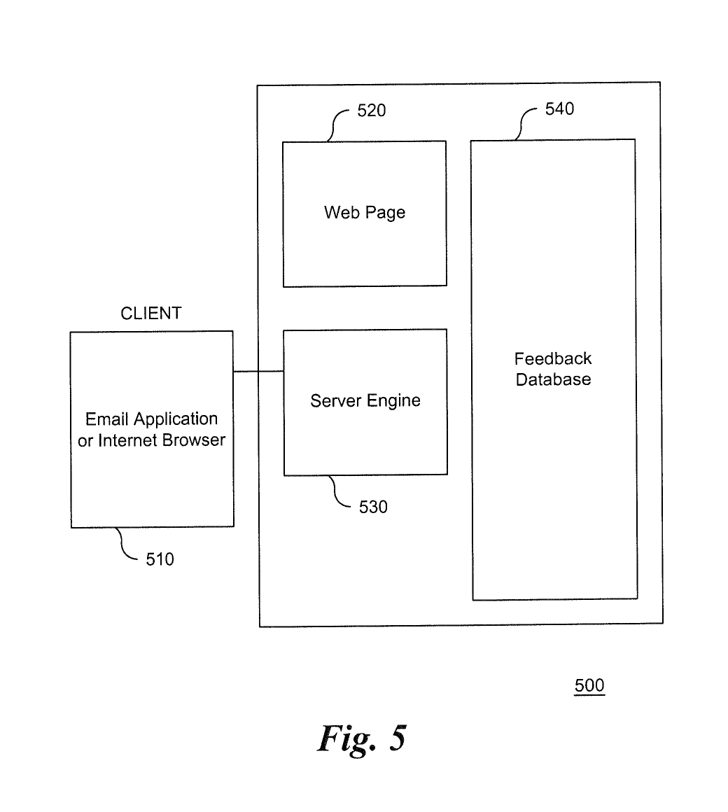

FIG. 5 illustrates an exemplary simplified system 500 for implementing the single-action feedback method according to an embodiment of the present disclosure. As shown, a client or user may utilize a personal computer, handheld electronic device, or other network accessible computer to access an email application or internet browser interface 510. Interface 510 communicates with a remote server, including a server engine 530, one or more generated web pages 520, and a feedback database 540. Server engine 530 may received HTTP requests or provide a web service. Server engine 530 may also be configured to parse feedback parameters that are received from the client, which are then stored on feedback database 540.

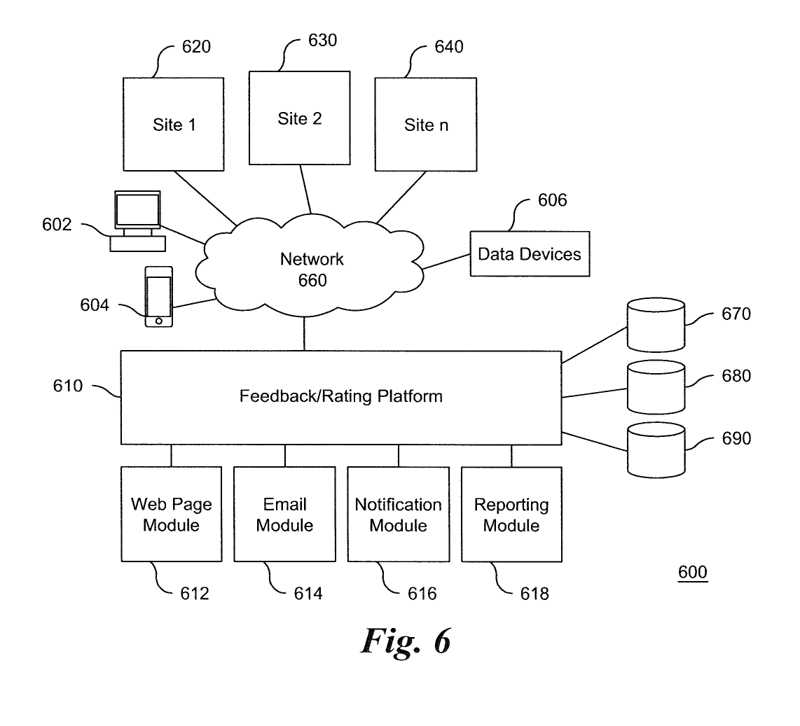

According to some embodiments, the single action feedback and rating system may be implemented by system 600 shown in FIG. 6. A Feedback/Rating platform 610 may be provided for interacting with client systems, generating feedback/rating graphics and emails for receiving feedback or rating input, and for storing and generating displays or reports corresponding to the feedback or ratings. By way of example only, the Feedback/Rating platform 610 may comprise a third-party computer system which is interconnected with a number of clients through a network to provide feedback/ratings support to the clients in relation to purchases and/or quality assurance. In other embodiments, the Feedback/Rating platform 610 may comprise a hardware device with suitable programming which may be installed by a client within the client's computer system.

In embodiments described herein, the Feedback/Rating platform 610 may provide feedback/ratings interfaces for a plurality of clients. For example, some clients may require feedback graphics interfaces in relation to customer online purchases, while other clients may require ratings graphics interfaces in relation to supply chain management quality assurance. The Feedback/Rating platform 610 may be integrated with any system that can benefit from feedback or ratings, and in embodiments may be connected with the computer system of any business through a network. Pursuant to some embodiments, the Feedback/Rating platform 610 may provide feedback/ratings graphics interface for systems 620-640, which may be connected to consumer or data devices 602, 604, 606. The consumer (e.g., mobile phone or computer) or data devices (e.g., special purpose scanner for quality assurance applications) 602, 604, and 606 receive the feedback/ratings graphics interfaces provided by the Feedback/Rating platform 610. The devices 602, 604, and 606 may then transmit the feedback/ratings data input to the Feedback/Rating platform 610. In embodiments, the graphics interfaces transmitted by the Feedback/Rating platform 610 to the consumer or data devices, and the feedback/ratings data input into the consumer device or data devices, may pass through one of the site computer systems 620, 630, 640 between the Feedback/Rating platform 610 and the consumer or data devices. In another embodiment, the processing platform 610 may transmit interfaces to consumers and data devices 602, 604 or 606 directly, and the input into the consumers and data devices may be transmitted directly from those devices to the Feedback/Rating platform 610.

As used herein, devices including those associated with the Feedback/Rating platform 610, and any other device described herein, may exchange information via any communication network 660 which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

Sites 620-640 may comprise computer systems for any client which sells goods or services, any client which performs quality assurance product or service reviews, or any other client which uses feedback or ratings in some manner in their business. Sites 620-640 may generate web sites which enable and facilitate the sale of goods and services by customers through customer devices such as personal computers and mobile telephone devices. Sites 620-640 may also comprise computer systems which use ratings and feedback for internal quality control. For example, site 620 may correspond to a customer service department of a goods or services company, which provides services to customers to answer inquiries or remediate problems, and which uses feedback to assess the quality of the service interactions with the customers.

As shown in FIG. 6, the Feedback/Rating platform 610 may include a number of modules or components, including a web page module 612 and an email module 614. In embodiments in which the feedback graphic is to be provided on a web page, web page module 612 may generate the web page for transmission to the client device and display on the client device. In embodiments in which feedback graphic is to be provided via an email, the email module 614 may generate the email with the feedback graphic and transmit it to the customer. Alternatively, the email module 614 may generate an email with a URL link for the client to access a feedback graphic. In one embodiment, the feedback graphic can be rendered (e.g. by making use of HTML tags such as the table tag), or it may comprise part of an application.

The Feedback/Rating platform 610 may also include a notification module 616 and/or a reporting module 618. Notification module 616 may be configured to provide notifications to a client in relation to feedback/rating data received from customers. For example, if the feedback rating platform is being used in relation to a production line in which products are rated as they are produced, the receipt of a threshold number of “Problem” input ratings by the platform may trigger the notification module to contact a production manager responsible for the product line. For example, receipt of a threshold number of “Problem” input ratings may trigger transmission of a text message to a mobile phone number of the production manager. In an embodiment, the feedback platform may be configured to provide to the client computer system a notification interface for receiving notification parameters for generation of a notification based on the feedback data received by the feedback platform computer system. The notification parameters may include the trigger which causes generation of a notification, the type of notification message generated, the person to whom the notification is sent, and the method or means by which the notification is sent, such as by email or text message. The notification interface receives the notification parameters, and generates notifications based on the notification parameters. Transmittal of the notification is made according to method parameter.

Reporting module 618 may be configured to generate reports based on historical feedback/rating data received via the multi-dimensional graphics. The reports may be individualized and configured for client needs, and may be transmitted to the clients in the manner preferred by the clients, such as via an email or through a reporting interface that may be logged into by the client. In an embodiment, the feedback platform computer system is configured to provide to the client computer system a report generation interface for receiving report parameters for generation of a report based on the feedback data received by the feedback platform computer system. The report parameters may include parameters indicating the format of the report (e.g., which data fields are shown in the report, and in what order), the manner of transmittal of the reports to clients, and any summary formats to be included with the report. In embodiments, the report generation interface may be configured to provide the user sample templates of reports which may be generated, and the user may select a template as a report parameter which will be used to generate the report. The templates may be stored in data storage devices, and presented to the user through the report generation interface. After the report parameters are received by the feedback platform computer system via the report generation interface, a report may be generated based on the report parameters, and the report may be transmitted to the client based on the parameter corresponding to the manner of transmittal of the report.

In embodiments, the feedback/rating platform gathers all data possible from the user, such as the location of the user, the time of day of the rating, the day of the week of the rating, and even the type of computing device being used by the user. The gathering of this data permits the construction of a “Big Data” database in relation to feedback. The data may then be used to identify dynamic factors which may affect feedback, which permits the feedback recipient to predict or forecast feedback. For example, the data may suggest that a certain user or users are more likely to give higher ratings on a particular day of the weekend. Knowledge of the effect of this dynamic factor may in turn drive optimization processes which will result in higher ratings on other days.

Although a single Feedback/Rating platform 610 is shown in FIG. 6, any number of such devices may be included. Moreover, various devices described herein might be combined according to embodiments of the present invention. For example, in some embodiments, the Feedback/Rating platform 610 and modules 612-618 might be co-located and/or may comprise a single apparatus.

The Feedback/Rating platform 610 and the modules 612-618 may also store and access information in one or more databases 670, 680 and 690. The databases may include, for example, a database library of different feedback/ratings graphics types or templates for use by different types of clients, a database of customized feedback/ratings graphics for use by different clients, and a database of feedback/rating data input by customers into feedback/ratings graphics in relation to different clients. Other databases (not shown) may also be interconnected with the platform, including a database with templates for reporting feedback/reporting data, a database of customized report templates for individual clients, and a database with notification parameters corresponding to different clients, the parameters defining when (e.g., after a threshold number of “problem” rating data inputs are received) and how (e.g., by text message), and to whom (e.g., a production supervisor) notification messages should be generated.

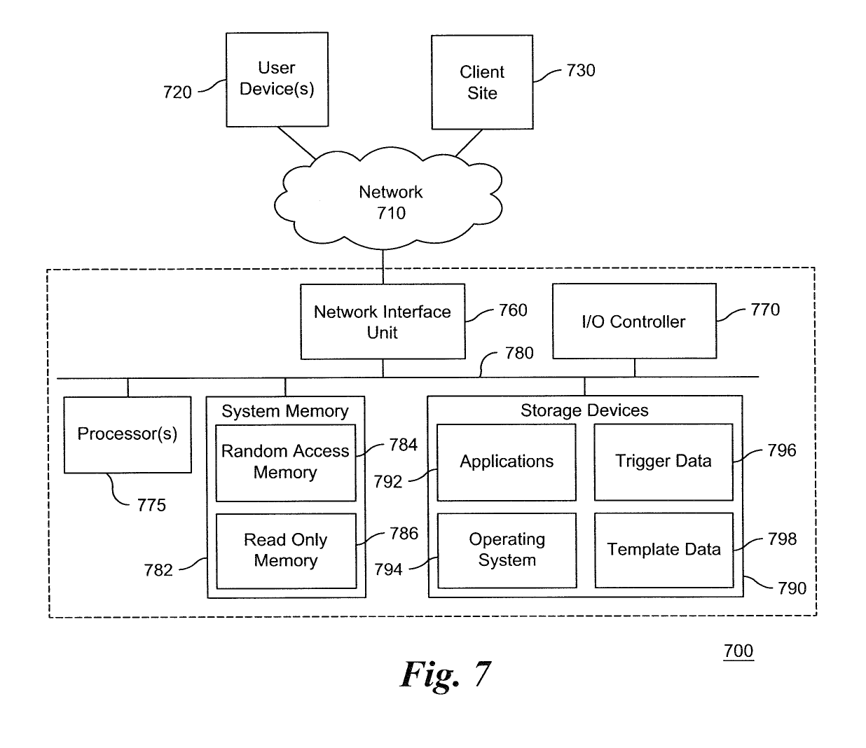

Referring now to FIG. 7, one embodiment of the Feedback/Rating platform 700 is shown for generating feedback/rating graphics interfaces and receiving feedback/rating input from a user through the graphics interfaces. As shown in FIG. 7, the Feedback/Rating platform 700 communicates via network 710 to send data to, and receive data from, a user device 720 (such as a mobile phone, computer, or the like), and a client site 730. While a single user device 720 and a single client site 730 are shown for clarity, the Feedback/Rating platform will typically communicate with a plurality of client sites, and with a plurality of user devices for each client site.

Feedback/Rating Platform 700 also may include a number of devices or components, including computer processor(s) 775. The computer processor 775 may include one or more microprocessors and may operate to execute programmed instructions to provide functionality as described herein. Among other functions, the computer processor 775 may transmit feedback graphics interface data and retrieve input data from user device 720 via network interface unit 760 and input/output controller 770 via system bus 780.

Trigger data used by the feedback/ratings platform may be stored in a data store 796. The trigger data may, for example, include the notification parameters and rules or conditions that must be met in order for a notification to be generated and transmitted in relation to feedback/ratings input received for a client. The trigger data may also include rules or conditions that must be met for the single action feedback process to be enabled, such as receipt of data indicating the completion of a sale or the completion of a customer service transaction. Template data may be stored in data store 798. For example, web page template data may be used to generate individualized feedback/ratings graphics interfaces for client feedback/ratings applications. Email template data may be used to generate individualized graphics interfaces for emails sent to customers of the client, to obtain feedback/ratings corresponding to a transaction with the client. Data store 798 may also include a database with templates for reporting feedback/reporting data, a database of customized report templates for individual clients, and a database with notification message templates. The templates may be used in conjunction with configuration interfaces. For example, a notification configuration interface may obtain parameters corresponding to different clients, the parameters defining, for example, when (e.g., after a threshold number of “problem” rating data inputs are received) and how (e.g., by text message), and to whom (e.g., a production supervisor) notification messages should be generated, and then use that parameter data with a template to generate notification messages. Similarly, Feedback/Ratings platform 700 may include other interfaces such as a web page configuration interface, an email configuration interface, and a report configuration interface, that obtain parameter data and use that data with templates.

The Feedback/Rating platform 700 may further include a system memory 782 that is coupled to the computer processor 775. The system memory 782 may include a random access memory 784 and a read only memory 786. System memory 782 is further coupled via bus 780 to one or more fixed storage devices 790, such as one or more hard disk drives, flash memories, tape drives or other similar storage devices. Storage devices 790 may store one or more application programs 792, an operating system 794, and one or more databases such as a web page template database 796 and an email template database 798 discussed above.

Feedback/Rating Platform 700 may be, according to some embodiments, accessible via a Graphical User Interface (GUI) rendered at least in part by input/output controller 770. The GUI might be used, for example, to dynamically display information associated with web and email templates, notification parameters, reporting parameters, and reporting templates, or the like.

Referring still to FIG. 7, the Feedback/Rating platform 700 performs processing to generate single action or touch graphics interfaces for receiving feedback/ratings input by a customer or user. The generation of single action or touch graphics interfaces may take a number of different forms, based on configuration of the system according to the needs of the particular client requesting the single action graphics interface. For example, the Feedback/Rating platform 700 may receive a notification from a client that a single action or touch feedback graphics interface is required for a customer who has completed a particular transaction, such as a product or service purchase or resolution of a customer service inquiry. In this example, the Feedback/Rating platform 700 is configured to provide the appropriate one touch feedback graphics interface to the client based on the type of transaction that has occurred. In another embodiment, the Feedback/Rating platform 700 may receive a notification from a client that a rating graphics interface is required for quality assurance in a production line or in relation to supply chain management. In this example, the Feedback/Rating platform 700 is configured to provide the client a series of rating graphics interfaces so that a production line of products may be rated. In embodiments, additional one touch feedback graphics interfaces are provided to the client after the receipt of input from the previous interface, until the user indicates that no additional feedback graphics interfaces are required or until a threshold amount of time has passed without the entry of a rating, which may indicate that the client has rated all available products.

It is contemplated that the Feedback/Rating platform 700 may generate feedback/ratings graphics interfaces in one or more languages, such as English, French, Arabic, Spanish, Chinese, German, Japanese and the like.

FIG. 8 illustrates a process flow diagram 800 of an exemplary implementation of the single-action feedback method into an existing online feedback service platform. As illustrated, a user may raise an inquiry 810 (e.g. a customer service request) to a client platform or client computer system. This inquiry may be made through the client customer service desk or department via telephone 820, or through the client's online resources (e.g. via a website) 830. An open inquiry 840 may be forwarded within the client platform to a support or customer service team 850 for processing. Processing of the inquiry by the support team 850 may result in the issue being resolved 860, which may include the support team providing an indication within the client computer system that issue has been resolved (e.g. an inquiry which has been addressed by the customer service team). For example, the support team may update a “status” field within the client platform to “resolved.”

Upon resolution of the inquiry, a notification 865 may be sent to the Feedback/Rating platform 880 to initiate a feedback interaction between the user and the a Feedback/Rating platform 880. In embodiments, the client system may already be configured to generate a communication 865 to indicate a resolved status to an existing feedback gathering platform, such as the FAIRpoints.CH Cloud feedback gathering platform. Alternatively, the client system may, upon implementation of the single point feedback graphic, be configured to provide such a notification.

When Feedback/Rating platform 880 receives a communication or indication from the client platform corresponding to the resolved inquiry, the Feedback/Rating platform 880 causes the feedback platform to generate a feedback graphics interface, transmit it to the user 890, and then receive the user input to the feedback graphics interface back from the user. In the embodiment of FIG. 8, the existing feedback gathering platform is configured to generate the single action feedback graphic and transmit it to the user 890. In embodiments, the existing feedback gathering platform may include the hardware and software necessary to generate the single action feedback graphic. In other embodiments, the existing feedback gathering platform may be configured to obtain the single action feedback graphic from a third party platform configured to generate the graphic. Once feedback information regarding the handling of the inquiry has been received from the client 890, this feedback information may be assigned 875 or associated with the inquiry, and the status of the inquiry marked as closed.

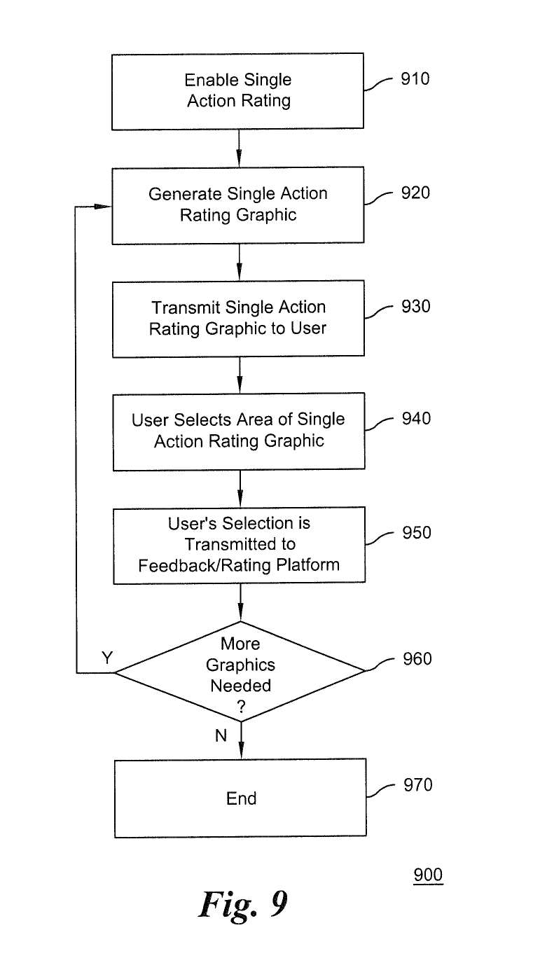

FIG. 9 illustrates an exemplary method according to the present disclosure which may be used, for example, by industrial scanners to rate incoming products, such as part of an Industry 4.0 Supply Chain Management system for quality assurance. At block 910, the single action/single action rating system is enabled. In embodiments, the single action ratings system may be enabled by the client's system, such as the selection of an icon on a device used by the client to rate products. In other embodiments, the single action ratings system may be enabled by the Feedback/Rating platform, upon receipt of a request from a client system. After enabling of the ratings system, at block 920 a graphical image (or rating graphic) having regions or areas thereof associated with various rating criteria is generated. At block 930, an electronic communication is generated which includes the rating feedback graphic and is sent to a device of the client such as an industrial scanner. At block 940, the client may select an area of the rating feedback graphic associated with one or more desired rating values (e.g. via a click of their mouse or other computer input interface such as a touchscreen interface). Once selected, data corresponding to the input by the user is transmitted to the Feedback/Rating platform at block 950. In an embodiment, at block 960 the user may be asked if they would like another rating feedback graphics interface before the process returns to block 920. If the user responds affirmatively, the process returns to block 920 and another rating feedback graphic is generated and transmitted to the user for input. If the user responds negatively, the process ends at block 970. In another embodiment, after the data corresponding to the input by the user is transmitted to the Feedback/Rating platform, the process causes both a request block and a new rating feedback graphic to be presented to the user.

In yet another embodiment, after the data corresponding to the input by the user is transmitted to the Feedback/Rating platform, the process returns to block 920 to generate another rating feedback graphic without the request of block 960 being presented to the user. This embodiment may be preferable when a series of products are being rated such as in a supply chain or inventory management system, and it is desired to receive a series of rating feedback graphics without delay. In this embodiment, the process may continuously generate multi-dimensional feedback graphics, transmit them, receive a selection from them, and store them, until the occurrence of an end event. In an embodiment, the end event may comprise the lapse of a predetermined period of time without receiving rating data from the quality assurance computing device after the transmitting of the multi-dimensional rating graphic to the quality assurance computer device. This is interpreted as an end event which stops the generation and transmission of additional feedback graphics. In another embodiment, the multi-dimensional rating graphic may include a discrete selectable area corresponding to an “END” command. In this embodiment, receipt of selection of the END command may be the end event which stops the generation and transmission of the feedback graphics.

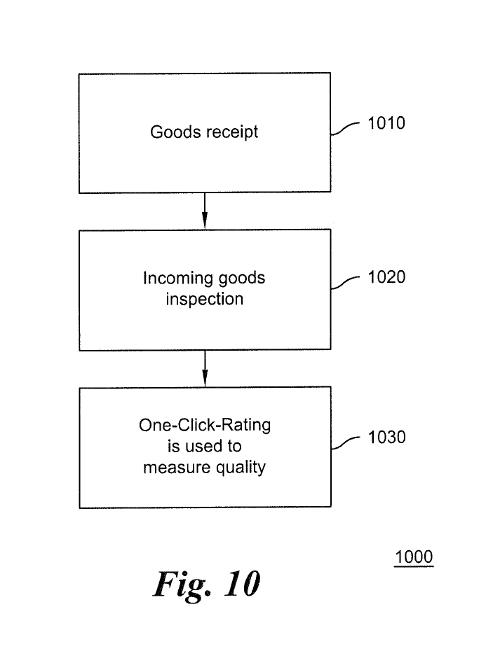

FIG. 10 illustrates a simplified exemplary method 1000 according to the present disclosure which may be used to rate incoming products. At block 1010, goods may be received by a client, perhaps as part of a supply chain management order. At block 1020, the incoming goods are inspected, and at block 1030 the single action multidimensional feedback graphic is generated for a user to rate the quality of each product received.

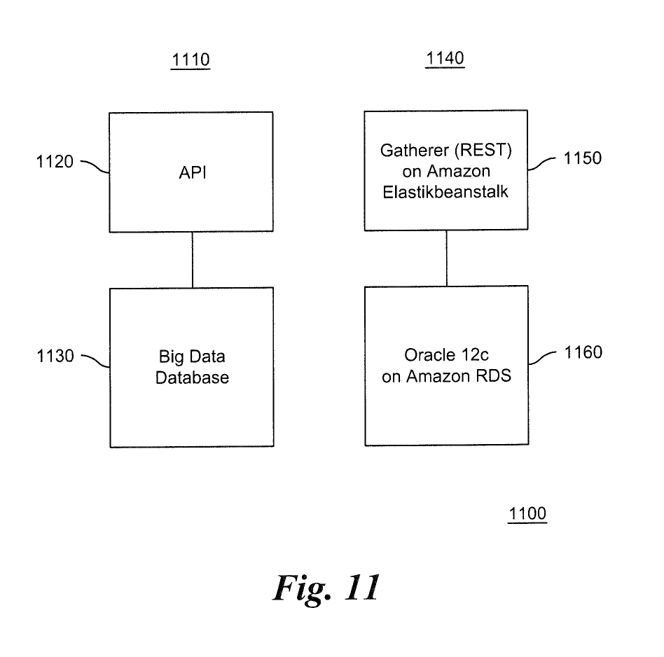

FIG. 11 illustrates configurations which may be used to implement the multidimensional feedback graphic platform. As shown in the configurations 1100 of FIG. 11, high-level configuration 1110 includes an API (application program interface) 1120 which is coupled to a Big Data Database 1130. Rating data may be input via any suitable API and stored in the associated database 1130. In specific configuration 1140, the API comprises REST (Representable state transfer) technology, which accepts the ratings and other data that needs to be stored in the Database 1160. The REST shown in setup 1140 is implemented on the AMAZON Elastic Beanstalk Platform as a Service, however the API may be implemented on other platforms, such as Microsoft Azure Web Sites, Cloud Foundry, Bluemix, AppScale, Google App Engine, Heroku, Engine Yard, OpenShift and Jelastic. Similarly the Database 1160 shown in practical setup 1140 is an ORACLE 12c on AMAZON RDS, which is optimized for cloud based operation, but may be implemented with other databases.

In an embodiment, a REST call may be used to submit a rating input by a user to a multidimensional feedback graphic. By way of example, the REST call may call an URL when the user clicks or touches on an area of the graphic, such as the URL: https://oneclickrating-dev.elasticbeanstalk.com/gaatherer/ocr/?r=qua2vel4&t=t345434&sk=skin01&h=3432233

This exemplary URL may be analyzed by its constituent parts as follows:

https:// indicates that the secured hyper text transfer protocol is being used

onelickrating-dev.elasticbeanstalk.com is the name of the server

gatherer/ocr is the URI to identify the correct service.

?r=qua2vel4 is the rating that was received (here the QUA (quality) was bad (rating 2), but the VEL (velocity) was good (rating 4))

&t=t4345434 identifies the ticket or incident to which the rating belongs

sk=skin01 indicates that skin01 was used to generate the multidimensional feedback graphic

&h=3432233 is the security token, that is used to provide security (in an embodiment it's a hash that works like a one-time password)

The calling of the URL causes the rating to be stored in a proper location in the big data database.

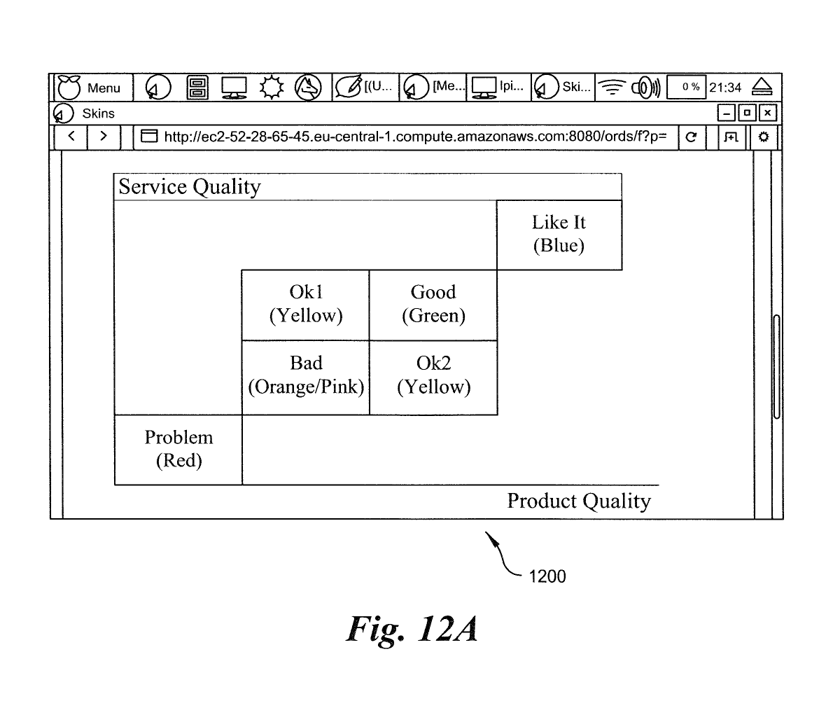

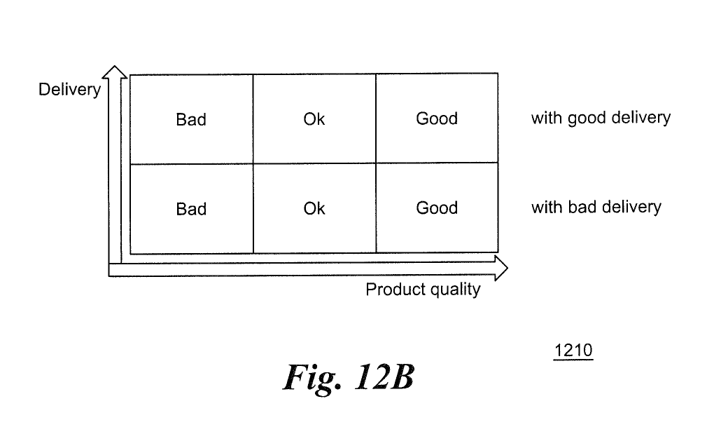

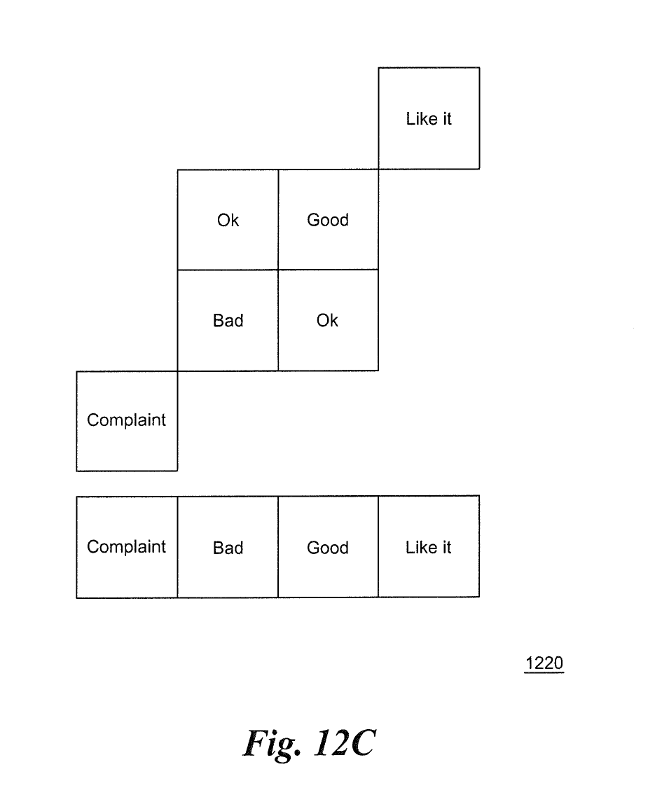

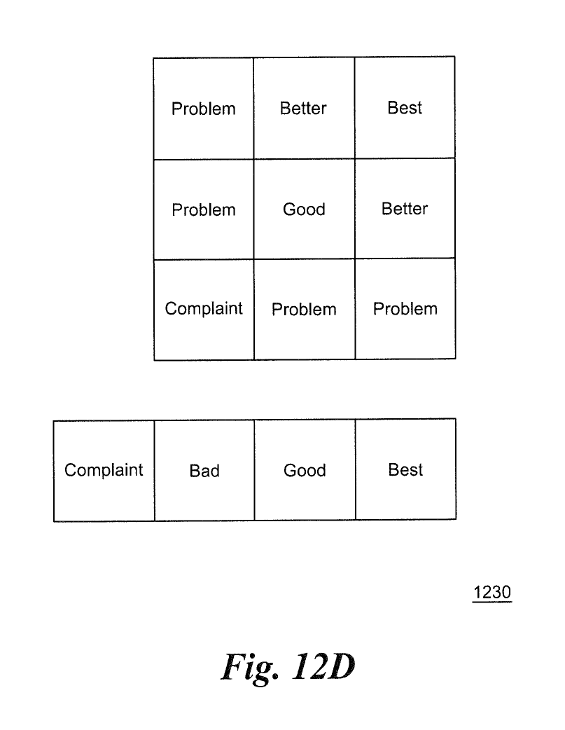

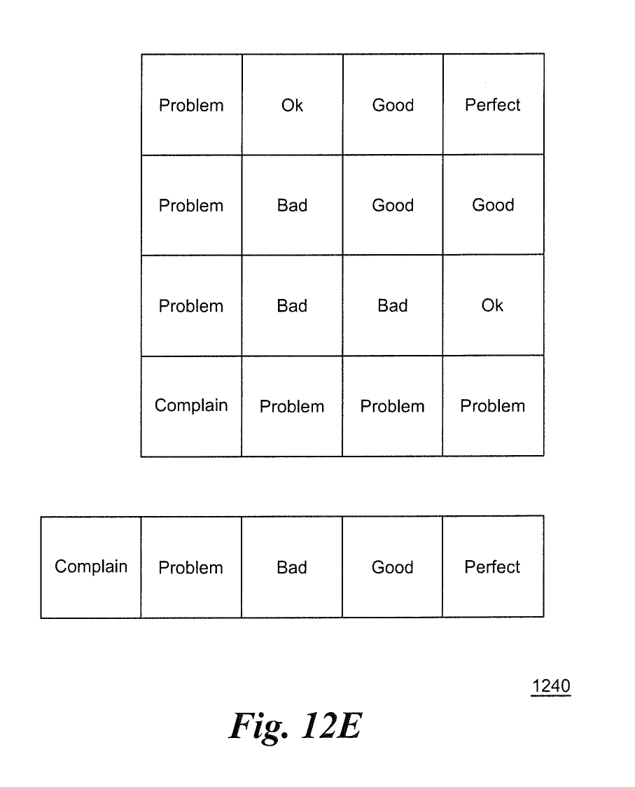

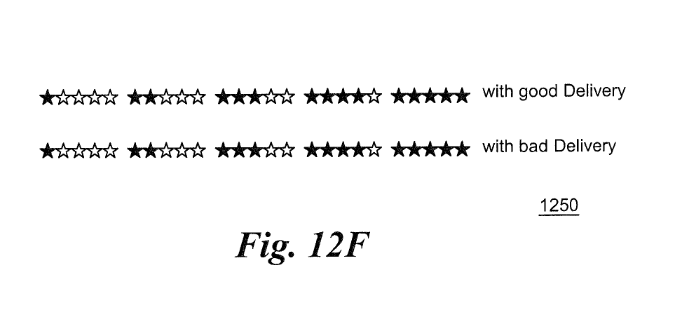

FIG. 12A illustrates a first exemplary rating feedback graphic used in the single-action feedback method of FIG. 9. As set forth, this rating feedback graphic may be sent to a client upon request by the client, such as to rate incoming products as part of a supply chain management or inventory management system. The exemplary rating feedback graphic shown consists of areas representing a combination of feedback parameters and associated ratings. In the illustrated two-dimensional embodiment, two distinct parameters or ratings can be measured; the X-Axis is associated with a first rating (e.g. rating 1, a Quality Rating); the Y-Axis is associated with a second rating (e.g. rating 2, a Velocity Rating). As shown, rating feedback graphic includes selectable areas “Bad,” “Good,” “OK1,” and “OK2.” In addition, the rating feedback graphic includes selectable areas “Problem” and “Like It.” The selectable area associated with box “Good” (which in a color display may be shown in green) and represents the optimal, and therefore a good feedback value of 2 for rating 1 and rating 2. The selectable areas associated with illustrated boxes “OK1” and “OK2” (which in a color display may be shown in yellow) have respective rating values of 2 and 1 for rating 1 and a rating value of 1 and 2 for rating 2. The selectable area associated with box “Bad” (which in a color display may be shown in orange or pink) represents a lower quality product or service, and therefore lowest rating or feedback value of 1 for both rating 1 and rating 2. As noted, the graphic also includes selectable areas “Problem” and “Like It.” In embodiments, the selectable area “Problem” (which in a color display may be shown in red) may be associated with a product which is worse than a product with a rating of “Bad,” and which corresponds to ratings values of 0 for both rating 1 and rating 2. For example, the “Problem” area may be selected when parts are missing from the product, which could adversely impact production use of the parts and cause an entire production line to step, which can be cost-intensive. Early identification of the problem and selection of the “Problem” area can cause the problem to be addressed immediately. The selectable area “Like It” (which in a color display may be shown in blue) may be associated with a product which is very good, which corresponds to ratings values of 3 for both rating 1 and rating 2.

In embodiments, the multidimensional feedback graphics may be implemented as skins which change the look of the graphic. FIG. 12B depicts a single action multidimensional graphic 1210, which may be implemented as a skin, in which two different parameters, delivery and product quality are rated. The graphic includes 2 different ratings for delivery, good and bad, and three different ratings for product quality, bad okay and good. FIG. 12C depicts a single action multidimensional graphic 1220, which may be implemented as a skin, in which two different parameters (which are not specified in the example) are rated. The graphic includes 2 different ratings for both parameters, as well as additional “Complaint” and “Like It” discrete areas which may also be selected, perhaps to simplify the process for a user. FIG. 12D depicts a single action multidimensional graphic 1230, which may be implemented as a skin, in which two different parameters (which are not specified in the example) are rated. The graphic includes 3 different ratings for both parameters, resulting in a 3×3 graphic cube with more granularity than the 2×2 cube of FIG. 12C. FIG. 12E depicts a single action multidimensional graphic 1240, which may be implemented as a skin, in which two different parameters (which are not specified in the example) are rated. The graphic includes 4 different ratings for both parameters, resulting in a 4×4 graphic cube with more granularity than the 3×3 cube of FIG. 12D.

FIG. 12F depicts a different type of multidimensional graphic 1250 that may be generated by the feedback rating platform, and which may be offered as a skin to a user. Rather than depict the different parameters in terms of a cube, the graphic of FIG. 12F includes two parameters which are presented in two levels corresponding to “with good delivery” and “with bad delivery.” The graphic of FIG. 12F addresses a problem encountered by large online stores when customer rate products only according to a single parameter, and rate the product poorly (such as with a single star) even though the product itself was acceptable but the delivery was bad. The use of the multidimensional feedback graphic with different delivery levels permits a more accurate rating to be given to the product which is independent of the shipping rating.

While FIGS. 12A-12F illustrate two-dimensional rating feedback graphics, it should be understood that other rating feedback graphics according to embodiments of the present disclosure may take on other forms. By way of non-limiting example only, a three-dimensional rating feedback graphic in the exemplary form of a three-dimensional cube such as shown in FIG. 3 may be generated (using, by way of non-limiting example, the WebGL API). This embodiment provides for three discrete feedback rating parameters and associated ratings. The cube comprises a plurality of discrete feedback areas or sub-cubes associated with various combinations of feedback parameters and ratings. As discussed in relation to FIG. 3, in embodiments the cube may be decomposed (e.g. separated), rotated, or otherwise manipulated by a client using an input interface device (e.g. a mouse) in order to access an area, box or sub-cube associated with a target (e.g. desired) feedback combination. In other embodiments, the cube may be presented as part of a hologram or virtual reality system, which allows the users to “touch” the discrete areas of the cube using the hologram and virtual reality technology.

While two-dimensional and three-dimensional graphics are shown providing feedback for two and three discrete ratings or parameters, respectively, it should be understood that the additional dimension of time may be included for each of these graphics for providing a client or user with additional feedback criteria. For example, the feedback graphic may change with time in order to present a user with additional selection options or feedback parameters from which to select.

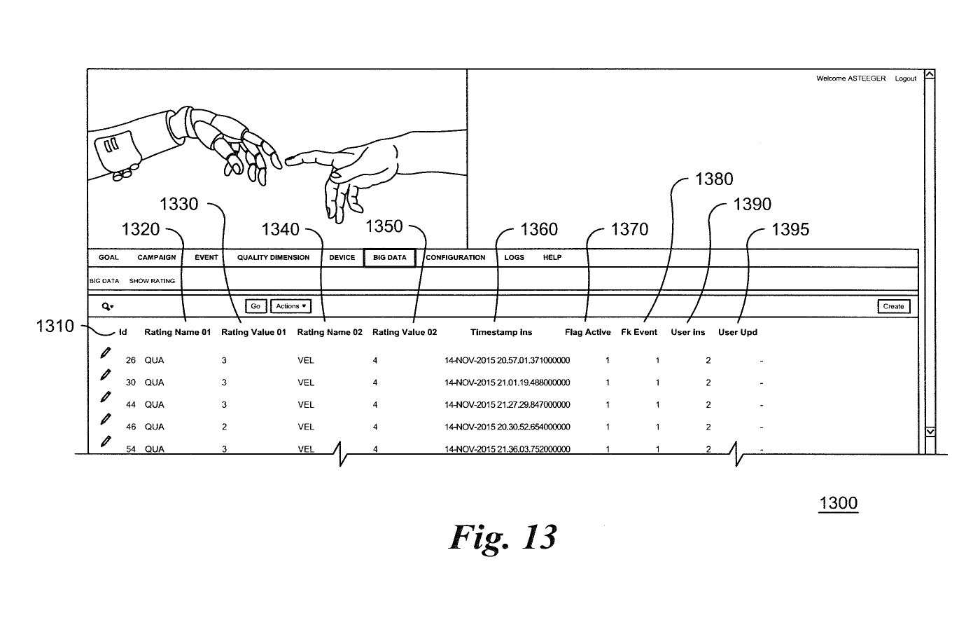

FIG. 13 illustrates a report 1300 that may be generated based on input received from a user. In an embodiment, the report includes a table with the fields: ID (1310), Rating Name 01 (1320), Rating Value 01 (1330), Rating Name 02 (1340), Rating Value 02 (1350), Timestamp (1360), Flag Active (1370), Fk Event (1380), User Ins (1390), and User Upd (1395). As noted in relation to FIG. 11, an API may use a REST call to accept the ratings data from the user devices which received the single action multi-dimensional feedback graphics. The Rating Name 01 field (1320) is the name of the first rating parameter, which may be VEL (Velocity), and Rating value 01 (1340) is the value which corresponds with the parameter. Rating name 02 (1350) and Rating value 02 (1360) are the name of the second rating parameter (such as QUA (Quality)) and its corresponding value. The Timestamp (1360) is the exact time the rating was persisted into the database. Flag Active (1370) is used to indicate if the rating to which it corresponds is active or was deleted. A value of 0 for Flag Active indicates that the rating was deleted, whereas a value of 1 for Flag Active indicates that the rating is active. Fk_Event corresponds to a foreign key for an event, which key indicates whether the ratings are associated with a certain campaign or event. The feedback platform may be configured to permit ratings data to be associated with particular campaigns and events, by allowing to associate certain events with particular Fk_Event codes. For example, a customer may set up an Fk_Event code 01 which is associated with a campaign to improve Just-In time production, and an Fk_Event code 02 which is associated with a campaign to rate all incoming goods/parts in the next four weeks. In an embodiment, the ratings data could be stored in the table as Fk_Event 02, as the ratings data is also imported to a separate event table from which campaign id 01 events could be looked up. The User_Insert (1390) and User_update (1395) fields are used to store data corresponding to the users who have initially provided or inserted the ratings, and users who have changed the rating. In an embodiment, if a user corrects one setting, then the original row in the database corresponding to the original settings is set to flag_active 0 and the a new row with the new settings is generated which includes a value of flag_active 1. In addition, in the original row the user_id of the person who generated the ratings is stored in user_insert column, and in the newly generated row with the new rating data the same user id is now stored in the column user_update, as part of a data history concept used by a client. In embodiments, the user id may be a technical user ID, if the rating is automatically done. After the report is generated, it may be transmitted to the client.

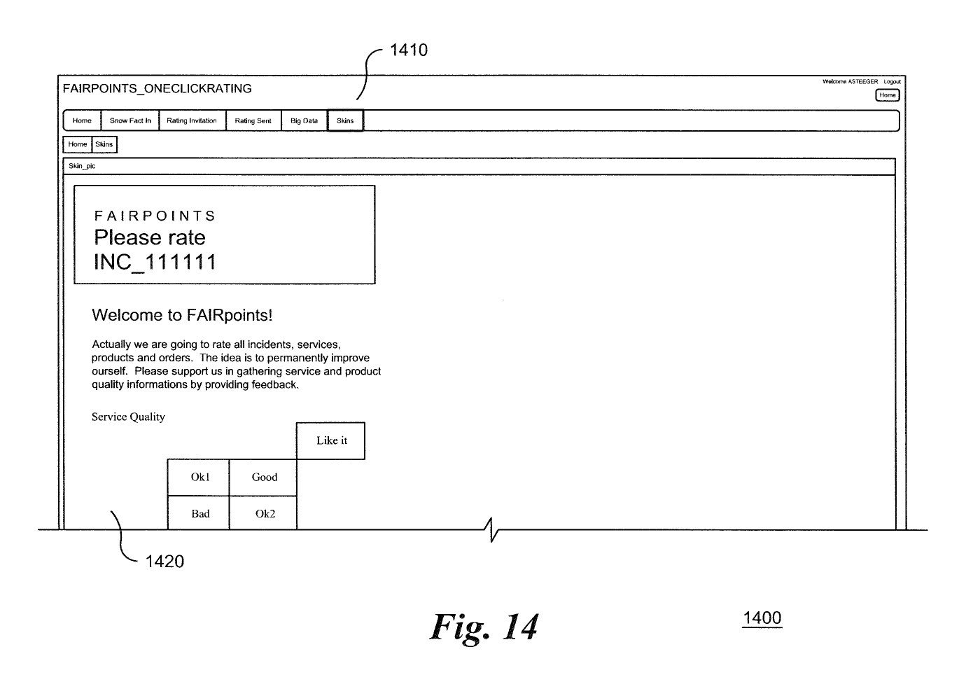

FIG. 14 illustrates an interface 1400 which allows a client to configure the type of single action multi-dimensional feedback graphic that is generated. As noted in relation to FIGS. 6 and 7, the feedback/ratings platform may include a database library of different feedback/ratings graphics types or templates for use by different types of clients. The database library may include different skins (such as shown in FIGS. 12A-12F), which constitute different graphics types from which a user may select. A partial view of feedback graphic 1420 is shown as an example of one of the skins which may be selected. The interface 1400 may include a tab 1410 for the user to access different skins. In embodiments, a feedback graphic configuration interface may be provided by the feedback platform computer system to the client computer system, for receiving feedback graphic parameters for generation of a multi-dimensional feedback graphic (such as a selected skin) when the single action feedback process is enabled. The feedback graphic parameters may include parameters such as the number of parameters of feedback (e.g. 2 or 3), the types of feedback parameters (e.g., communications, velocity, service as described), and the value range of the feedback (e.g. 1-3 or 1-5). The feedback graphic configuration interface may be configured to allow the user to select and set different feedback parameters, such as in relation to a selected skin. In an embodiment, the interface is configured to receive feedback graphic parameters for at least the parameter of number of parameters to be included in the multi-dimensional feedback graphic. The interface may also allow the user to select the lettering and labels for the axes of the multi-dimensional graphic.

The interface of FIG. 14 may include an inquiry system to request information needed to select the proper template, such as an inquiry system which asks the user how many parameters of distinct data are needed for the feedback graphic, and what type of application (e.g. supply chain management ratings or customer service feedback) the feedback graphic will be used for. In embodiments, the selection of a graphic for a particular type of application may result in selection of a template for which all of the graph parameters are pre-selected. In another embodiment, the interface may present the user with drop down menus which allow the user to select different options for the template desired, including number of parameters (e.g., 2 for dimensional template and 3 for 3 dimensional template) and rating score range (e.g. 1-3 or 1-5).

After the feedback platform computer system receives the feedback graphic parameters, the parameters may be stored in a data storage device associated with the particular client. When a feedback graphic is required, the multi-dimensional feedback graphic is generated based on the relevant feedback graphic parameters.

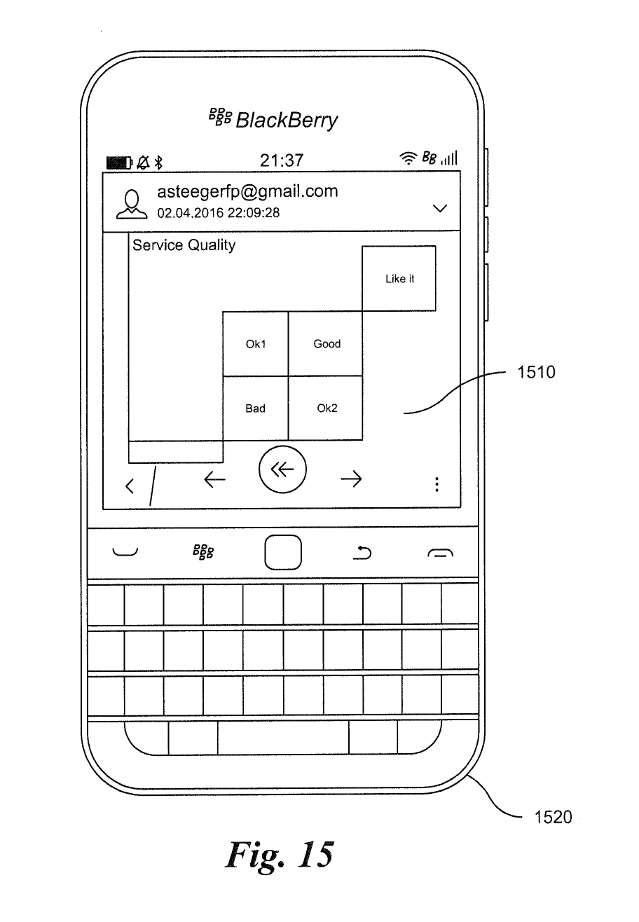

The feedback graphics generated by the feedback/rating platform may be transmitted to a variety of user devices and is viewable and usable on the different devices. FIGS. 15 and 16 depict feedback graphics (1510 and 1610) which are generated on a Blackberry device 1520 and an iPhone device 1620. Alternatively the feedback graphics may be sent to personal computers, tablets, and other computing devices which have a display and a selection interface such as a touchscreen or pointing device. Further, as noted, the feedback graphics may also be implemented with holographic and virtual reality systems.

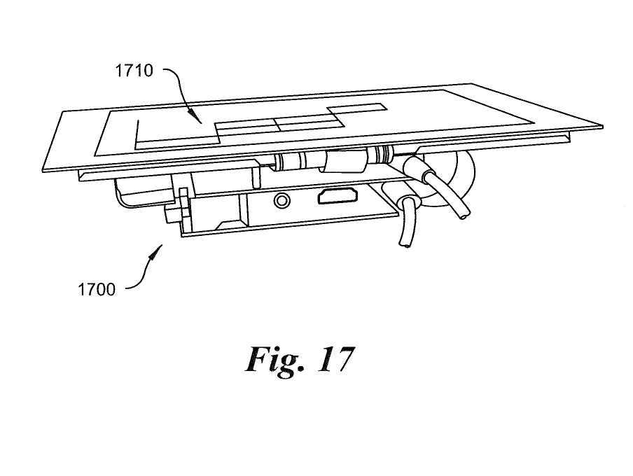

In other embodiments, the feedback rating process may be implemented by a special purpose device 1700 as shown in FIG. 17, which is a special purpose industry ratings scanner device which may be used in relation to supply chain management applications. In embodiments, the ratings scanner device may be configured to generate a multi-dimensional rating graphic 1710, which includes a plurality of discrete selectable areas, each of the plurality of discrete selectable areas corresponding to distinct rating values of at least two rating parameters. The ratings scanner device may be further configured to render the multi-dimensional rating graphic on a display of the scanner device, so that the graphic display may be used to rate products. In embodiments, a discrete section of the graphic may be selected, for example by a click of a mouse by a user or by touching the screen of the device, if the device is equipped with a touchscreen. After the selection is received, the feedback data corresponding to the selection is saved in a data storage device. The data storage device may be part of the scanner, or may be part of a computer system coupled to the scanner.

In a supply chain management application, a user may be required to rate a series or line of products being received. In an embodiment each of the products will be rated by the user, and the ratings scanner device is configured to generate a series of single action multi-dimensional ratings graphics so that each product may be rated. In an embodiment, rather than requiring a user to request a new graphic for each product, the device or platform may be configured to provide the client a series of rating graphics interfaces so that the entire line of products may be rated, until an event occurs which signals the end of the product line. In embodiments, additional one touch feedback graphics interfaces are provided to the client after the receipt of input from the previous interface, until an “end” event occurs, such as the user indicating that no additional feedback graphics are required (via an “END” display on the graphic) or until a threshold amount of time has passed without the entry of a rating, which may indicate that the client has rated all available products. The device is thus configured to continuously repeat generation of graphics, rendering of the graphics on the display of the device, receive a selection of discrete area, and store the ratings data, until the occurrence of the end event.

In another embodiment, the generation of feedback graphics on a display of the scanner is triggered by the scanner scanning an RFID tag of a product. After the product is scanned, the information in the RFID tag is received by the feedback platform and stored in memory, and the multidimensional feedback graphic is displayed to the user to receive user input. This process may repeat until the final product received is scanned and the final corresponding multidimensional feedback graphic is displayed to the user to receive user input. The system may be configured to recognize that when an input is received but not followed by a scan of an additional product, additional multidimensional feedback graphic need not be generated.

In an embodiment, the special purpose device 1700 may be an industrial scanner which incorporates RFID (radio frequency identification) and/or NFC (near field communication, a type of RFID) technology, such as an RFID and/or NFC board, to scan RFID tags which have been placed (typically by the manufacturer) on the products or packaging of the products to be rated. The RFID tags on the product typically include memory which can store a small amount of data (e.g., 4 kb), and the scanner may be configured to use that memory by storing in the memory the rating results for the product, as input by a user on the single action multidimensional rating graphic on the screen of the device and then transmitted by the RFID and/or NFC board on the device to the RFID tag. In addition, the RFID tag will typically include information about the product such as product model information and a specific ID associated with the particular item being scanned. The scanned data may then be associated with the rating generated for the product through the multidimensional graphic.

The use of the industrial scanner and storage of the ratings information in the RFID tag permits the implementation of an Inversion of Control system in which products that are rated may later be sorted according to their ratings. In an embodiment, a scanner may be configured to read the rating information stored in the RFID tag so that sorting out or removal of products with insufficient ratings (e.g., ratings which do not meet a predetermined threshold) may be performed. The sorting may be performed by a human with a scanner, such as a scanner which generates a display which indicates whether the product should be removed. For example, the display may simply be a red screen for products which should be removed from the line or conveyor, and a green screen for products which should be allowed to continue to production or inventory. The sorting may alternatively be performed by an automatic system which scans the ratings data on the RFID tag, and then automatically mechanically routes (such as through the use of different conveyors) the products to be removed to a different location than acceptable products. Similarly, the ratings information may also be used to determine other next actions that may be taken, such as the fixing of a product for which a common issue (e.g., poor paint) is present in the ratings.

Furthermore, the storage of the rating information in the RFID for products provides for an efficient process for correcting or remediating the problems with the products. For example, if the goods/parts/products are sent back to a vendor as a result of the poor rating, the vendor can read the ratings from the RFID chip, immediately identify the problem with the products, and quickly implement processes (such as repainting of products which were rated poorly because of poor paint) to fix the issue. Similarly, if it is the vendor who has implemented the multidimensional feedback graphic and RFID system to rate products before they are shipped to customers, the presence of the rating on the RFID tag allows the vendor to more quickly implement solutions to fix the products.

The feedback platform using an unconventional RFID scanner with a display for implementing a multidimensional graphic rating system allows the implementation of a process which efficiently identifies products, as well as next actions, by analyzing the multidimensional rating using Big data, which helps to reduce costs. The use of the RFID scanner and multidimensional graphic rating system in supply chain management applications to store ratings information in RFID tags provides technical benefits by allowing the vendor to access the rating data without having to receive the data over communications between the vendor computer system and the client computer system, which completely eliminates the communications device, processor, and memory usage associated with such communications. Further, the storage of the ratings data in the RFID tag also eliminates the need to performing sorting at the same time as rating, which eliminates the technical complications involved with performing both actions at the same time.

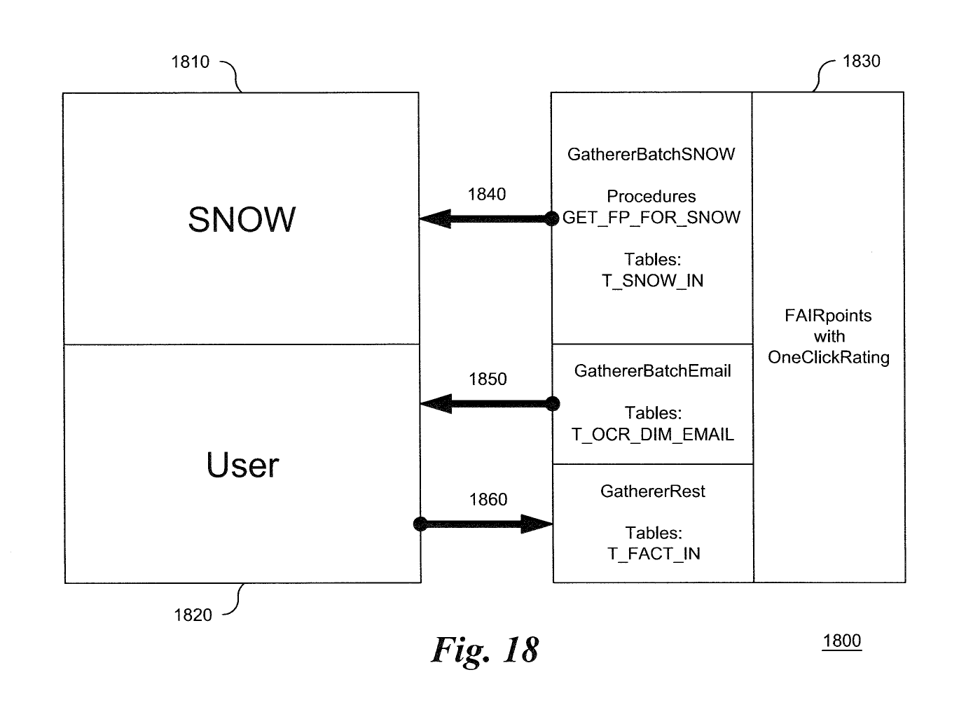

FIG. 18 depicts an implementation 1800 of a single action feedback interface with a service provider interface. As noted in relation to FIG. 8, the single action feedback graphics interface may be integrated with an existing feedback gathering platform. In the embodiment of FIG. 18, the single action feedback graphics interface is integrated with an existing incident management service platform known as “SNOW” 1810, which renders customer service services to users 1820. The single action feedback graphics interface is integrated with SNOW via a separate feedback platform, in this embodiment the FAIRpoints.CH with OneClickRating (or single action rating) 1830 feedback platform. In this embodiment, the FAIRpoints.CH Cloud feedback gathering platform 1830 generates single action feedback graphics for emails to be sent to users upon completion of a customer service interaction. In the embodiment, the FAIRpoints.CH Cloud feedback gathering platform 1830 obtains or pulls data concerning completed customer service transactions from the SNOW platform 1810 in batches 1840. The FAIRpoints.CH Cloud feedback gathering platform 1830 is also configured to obtain or pull data 1840 concerning users of the completed customer service transactions (such as email addresses) from the SNOW platform 1810. Based on the batch data and email data, the FAIRpoints.CH Cloud feedback gathering platform 1830 generates emails including single action feedback graphics interfaces for the users 1850, and receives back the data input by the users 1860. The implementation of FIG. 18 is similar to the configurations of FIG. 11.

The survey data received from the multi-dimensional feedback graphic may be used to optimize process steps, when the feedback received does not meet certain expectations such as a threshold positive or negative feedback value. For example, the received feedback may include data corresponding to two different ratings dimensions or parameter, such as quality and speed of customer service. If the feedback ratings for quality and/or speed do not meet a threshold positive feedback value (in a system which uses positive counting), processes relating to the ratings parameter which is deficient may be modified to increase positive feedback. Thus, if the speed of customer service receives low feedback inputs, processes to increase the speed of connection of customers to service representatives may be taken to address the low feedback.

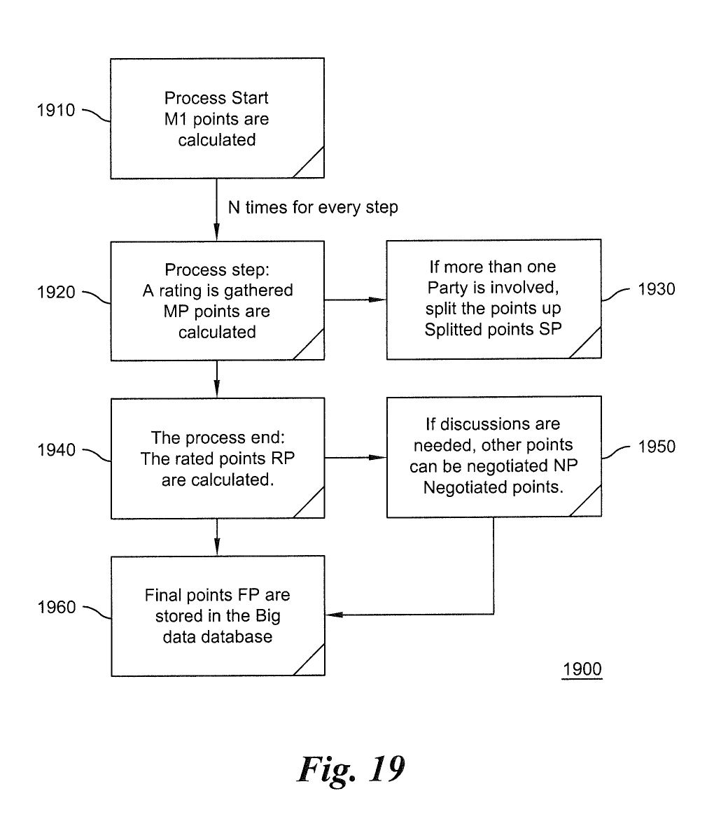

FIG. 19 depicts a process flow diagram 1900 of an optimization method which uses the feedback generated by the feedback platform using the multidimensional feedback graphic to optimize processes to thereby increase future feedback ratings. At the beginning of a process at block 1910, the system assigns initial points M1 to a component like an incident, a service or a product. For each process step for which feedback is desired, a feedback rating is gathered at block 1920 via a multidimensional feedback graphic, causing the points associated with the incident, service, or product to change, which may be known as Marked Points MP. If more than one party is necessary to pass the step, then the received points are split up at block 1930 (Submitted points SP). At the end of a process at block 1940, or in a preferable embodiment at the end of every process step, a multidimensional feedback graphic is generated and a rating is received. This again changes the points depending on the rating that has been provided (Rated points RP). If the rated points RP are of a certain value, they may indicate that discussions are necessary at block 1950 to negotiate points NP. Finally, at block 1960 the final points are stored in the Big data database. In embodiments a self-learning algorithm is used, which may cause the M1 Initial points to be recalculated and more precise in the ratings of later incidents, services, or products. In addition, if the amount of points inputted does not meet expectations such as a threshold value, that knowledge can be used to optimize the process step that was rated to improve future ratings.

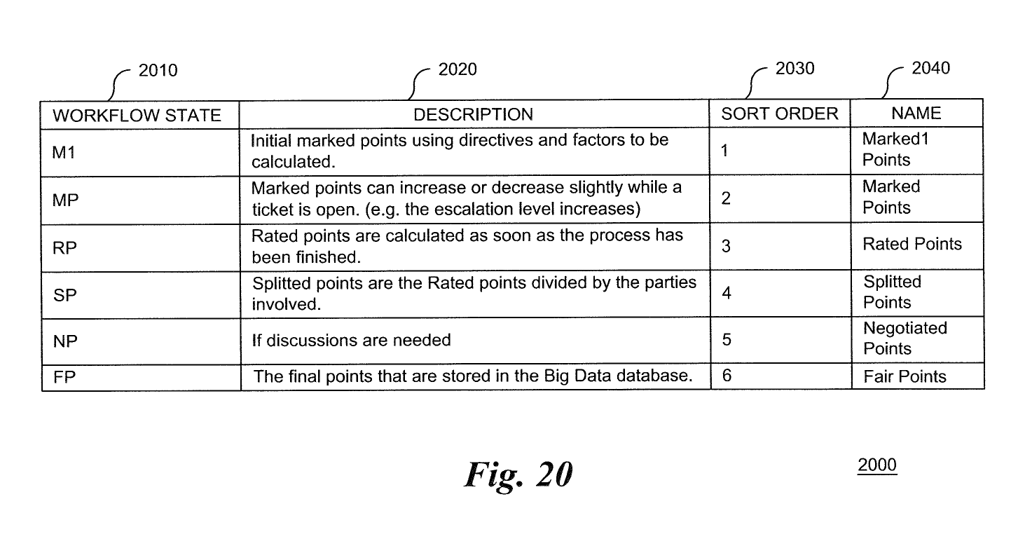

FIG. 20 depicts a workflow state chart which describes the points which are calculated and analyzed in relation to the method of FIG. 19. Column 2010 describes the workflow states, which, as described in relation to FIG. 19, include M1, MP, RP, SP, NP, and FP. Column 2020 provides a description of the workflow states, explaining that M1 corresponds to initial marked points, MP corresponds to points that may vary while a ticket is open, RP corresponds to rated points calculated when a process is finished, SP corresponds to split points, NP corresponds to whether discussions are needed, and FP corresponds to the final points. Column 2030 provides a sort order for the data, with data first being sorted according to initial points M1, then according to marked points MP, etc. Finally, column 2040 provides the name of the workflow state that corresponds to the abbreviation of column 2010.

It should be understood that the systems described above (e.g. personal computing devices, servers and the like) include one or more processors carrying out the instructions of computer programs, which operates and/or controls at the above-described functionality. Program instructions may be loaded into local memory of these devices. As used herein, the term “processor” broadly refers to and is not limited to a single- or multi-core general purpose processor, a special purpose processor, a conventional processor, a Graphics Processing Unit (GPU), an Applications Processing Unit (APU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

The flow charts described herein do not imply a fixed order to the steps, and embodiments of the present invention may be practiced in any order that is practicable. In embodiments, one or more steps of the methods may be omitted, and one or more additional steps interpolated between described steps. Note that any of the methods described herein may be performed by hardware, software, or any combination of these approaches. For example, a non-transitory computer-readable storage medium may store thereon instructions that when executed by a processor result in performance according to any of the embodiments described herein. In embodiments, each of the steps of the methods may be performed by a single computer processor or CPU, or performance of the steps may be distributed among two or more computer processors or CPU's of two or more computer systems. In embodiments, one or more steps of a method may be performed manually, and/or manual verification, modification or review of a result of one or more processor-performed steps may be required in processing of a method.

The embodiments described herein are solely for the purpose of illustration. Those in the art will recognize that other embodiments may be practiced with modifications and alterations limited only by the claims.

What is claimed is:

1. A computer-implemented feedback data generation method comprising:
receiving, from a client computer system, data indicative of enablement of a single action feedback process for capturing transaction feedback data from a customer computing device;
responsive to receipt of the data indicative of enablement, generating, by a feedback platform computer system, a multi-dimensional feedback graphic including a plurality of discrete selectable areas, each of the plurality of discrete selectable areas corresponding to distinct feedback values of at least two feedback parameters;
transmitting, by the feedback platform computer system, the multi-dimensional feedback graphic to the customer computing device for selection of one of the plurality of discrete selectable areas by a customer;
receiving, by the feedback platform computer system from the customer computing device, a selection of one of the plurality of discrete selectable areas on the multi-dimensional feedback graphic selected on the customer computing device, said selection comprising feedback data corresponding to the at least two feedback parameters corresponding to the selected one of the plurality of discrete selectable areas on the multi-dimensional feedback graphic; and
storing, in a data storage device, the feedback data.

2. The method of claim 1, further comprising:
providing, by the feedback platform computer system to the client computer system, a feedback graphic configuration interface for receiving feedback graphic parameters for generation of the multi-dimensional feedback graphic when the single action feedback process is enabled, said feedback graphic parameters including at least a first feedback graphic parameter indicative of at least a number of feedback parameters to be included in the multi-dimensional feedback graphic;
receiving, by the feedback platform computer system, the feedback graphic parameters;
wherein generation of the multi-dimensional feedback graphic is based on the feedback graphic parameters.

3. The method of claim 1, wherein the data indicative of enablement of the single action feedback process comprises data indicative of completion of an interaction between a client and a customer.

4. The method of claim 1, wherein transmitting the multi-dimensional feedback graphic to the customer computing device comprises one of (1) generating a web page which includes the multi-dimensional feedback graphic and transmitting the web page to the customer computing device; (2) generating an email including the multi-dimensional feedback graphic and transmitting the email to an email account of a customer associated with the customer computing device; and (3) generating an email including a Uniform Resource Locator (URL) link to the multi-dimensional feedback graphic, and transmitting the email to the email account of a customer associated with the customer computing device.

5. The method of claim 1, wherein each of the plurality of discrete selectable areas of the multi-dimensional feedback graphic corresponds to distinct feedback values of at least three feedback parameters.

6. The method of claim 5, wherein the multi-dimensional feedback graphic is rotatable; and
wherein the discrete areas of the multi-dimensional feedback are separable, thereby providing access to all of the discrete areas for selection.

7. The method of claim 1, wherein generating the multi-dimensional feedback graphic including a plurality of discrete selectable areas comprises generating one of a hologram including the multi-dimensional feedback graphic and a virtual reality display including the multi-dimensional feedback graphic.

8. The method of claim 1, wherein generating the multi-dimensional feedback graphic including a plurality of discrete selectable areas comprises generating the multi-dimensional feedback graphic so that one of the plurality of discrete selectable areas may be selected by a voice input.

9. The method of claim 1, further comprising generating a next action based on the feedback data corresponding to the input received to the multi-dimensional feedback graphic.

10. The method of claim 1, further comprising:
monitoring, by a client computer system, a plurality of customer service interactions with customers;
identifying, based on the monitoring by the client computer system, a resolution event for one or more of the plurality of customer service interactions;
performing the receiving, generating, transmitting, and receiving steps for one of the plurality of customer service interactions responsive to identification of the resolution event for the one of the plurality of customer service interactions.

11. The method of claim 1, wherein the generated multi-dimensional feedback graphic is configured to change over time such that one or both of (1) information displayed by one or more of the plurality of discrete selectable areas changes over time; and (2) the distinct feedback values corresponding to one or more of the plurality of discrete selectable areas changes over time.

12. The method of claim 1, further comprising continuously repeating the generating, transmitting, receiving, and storing steps until occurrence of an end event;
wherein the end event comprises one of: (1) receipt, by the feedback platform computer system, of selection of an end command provided on the multi-dimensional feedback graphic; and (2) a lapse of a predetermined period of time without receiving feedback data from the customer computing device after the transmitting of the multi-dimensional rating graphic to the customer computing device.

13. The method of claim 1, wherein the quality assurance device computing device comprises an RFID scanner, and
wherein receiving the data indicative of enablement of the single action feedback process comprises receiving RFID data from the RFID scanner corresponding to a product to be rated; and
further comprising continuously generating the multi-dimensional rating graphic, transmitting the multi-dimensional rating graphic to the RFID scanner, receiving the feedback data, and storing the feedback data for each product scanned by the RFID scanner.

14. A rating platform computer system comprising:
a network interface unit configured to receive data indicative of a request to enable a single action rating process for capturing transaction rating data from a quality assurance computing device;
a processor configured, responsive to receipt of the request to enable the single action rating process, to:
generate a multi-dimensional rating graphic including a plurality of discrete selectable areas, each of the plurality of discrete selectable areas corresponding to distinct rating values of at least two rating parameters;
transmit, by the network interface unit to the quality assurance computing device, the multi-dimensional rating graphic for selection of one of the plurality of discrete selectable areas by a client;
receive, by the network interface unit from the quality assurance computing device, a selection of one of the plurality of discrete selectable areas on the multi-dimensional rating graphic, said selection comprising rating data corresponding to the at least two rating parameters corresponding to the selected one of the plurality of discrete selectable areas on the multi-dimensional rating graphic; and
store, in a data storage device, the rating data.

15. The system of claim 14, wherein the network interface unit is also configured to receive delivery type data indicative of whether the multi-dimensional rating graphic will be presented to the customer via an email message or a web page; and
wherein the rating platform computer system further comprises:
a web page module configured to generate the web page including the multi-dimensional rating graphic, responsive to the delivery type data indicating that the multi-dimensional rating graphic will be presented to the customer via the web page; and
an email module configured to generate the email message including the multi-dimensional rating graphic, responsive to the delivery type data indicating that the multi-dimensional rating graphic will be presented to the customer via the email message.

16. The system of claim 14, wherein the rating platform computer system further comprises one or both of:
a notification module configured to:
generate a notification interface for receiving notification parameters for generation of a notification based on the rating data received by the rating platform computer system, said notification parameters including at least a first notification parameter indicative of a method of transmitting the notification to the client;
receive, by the network interface unit, the notification parameters; and
generate, based on the notification parameters, a notification; and
a reporting module configured to:
generate a report generation interface for receiving report parameters for generation of a report based on the rating data received by the rating platform computer system, said report parameters including at least a first report parameter indicative of a method of transmitting the report to the client;
receive, by the network interface unit, the report parameters;
generate, based on the report parameters, the report; and
transmit the report based on the first report parameter.

17. The system of claim 14, wherein the quality assurance device computing device comprises an RFID scanner, and
wherein the processor is configured to generate the multi-dimensional rating responsive to receipt of RFID data corresponding to a product scanned by the RFID scanner; and
and wherein the a processor is further configured to continuously generate the multi-dimensional rating graphic, transmit the multi-dimensional rating graphic to the RFID scanner, receive the rating data, and store the rating data for each product scanned by the RFID scanner.

18. A ratings scanner device comprising:
an RFID transceiver for receiving RFID data from an RFID tag and transmitting the RFID data to the RFID tag;
a display configured to display a multi-dimensional rating graphic and receive a selection corresponding to the multi-dimensional rating graphic;
a processor configured to:
receive, by the RFID transceiver, the RFID data from the RFID tag;
generate, responsive to receipt of the RFID data from the RFID tag, a multi-dimensional rating graphic including a plurality of discrete selectable areas, each of the plurality of discrete selectable areas corresponding to distinct rating values of at least two rating parameters;
render the multi-dimensional rating graphic on the display;
receive a selection of one of the plurality of discrete selectable areas on the multi-dimensional rating graphic, said selection comprising rating data corresponding to the at least two rating parameters corresponding to the selected one of the plurality of discrete selectable areas on the multi-dimensional rating graphic;
store the rating data in a data storage device;
store, by the RFID transceiver in the RFID tag, the rating data corresponding to the at least two rating parameters;
continuously repeat the generate, render, receive, and store steps for each product scanned by the RFID transceiver.

19. The device of claim 18, wherein the multi-dimensional rating graphic includes a discrete selectable area corresponding to an end command, and wherein the device is configured to end the generation of the multi-dimensional rating graphics upon selection of the end command.

20. The device of claim 18, wherein the processor is further configured to scan by the RFID transceiver the RFID tag of a previously scanned product and receive the rating data stored in the RFID tag of the previously scanned product.
